(19) United States
(12) Patent Application Publication
(10) Pub. No.: US 2024/0362355 A1
(43) Pub. Date: Oct. 31, 2024

(54) NOISY AGGREGATES IN A QUERY PROCESSING SYSTEM

(71) Applicant: Snowflake Inc., Bozeman, MT (US)

(72) Inventors: Khalid Zaman Bijon, Santa Cruz, CA (US); Monica J. Holboke, Toronto (CA); Stephen Joe Jonany, Seattle, WA (US); David Schultz, Piedmont, CA (US)

(21) Appl. No.: 18/647,728

(22) Filed: Apr. 26, 2024

Related U.S. Application Data
(60) Provisional application No. 63/499,040, filed on Apr. 28, 2023.

(51) Int. Cl. G06F 21/62; G06F 16/2455

(52) U.S. Cl. CPC G06F 21/6227; G06F 16/24556; G06F 16/24565

(57) ABSTRACT

A noisy aggregation constraint system receives a query for a shared dataset, where the query identifies an operation. The noisy aggregation constraint system accesses a set of data from the shared dataset to perform the operation, the set of data comprises data accessed from a table of the shared dataset. The system determines that an aggregation constraint policy is attached to the table, the policy restricts output of data values stored in the table. Based on the context of the query, the system determines that the aggregation constraint policy should be enforced in relation to the query. The system assigns a specified noise level to the shared dataset and generates an output based on the set of data and the operation; the output comprises data values added to the table based on the specified noise level.

### CROSS-REFERENCE TO RELATED APPLICATIONS

The present application claims benefit of earlier filing date and right of priority to U.S. Provisional Patent Application Ser. No. 63/499,040, filed on Apr. 28, 2023, entitled, “Noisy Aggregates in a Query Processing System,” all of the contents of which are hereby incorporated by reference herein in its entirety.

### TECHNICAL FIELD

The present disclosure generally relates to systems, methods, computer programs, and special-purpose machines that manage data platforms and databases and, more specifically, data platforms for implementing noisy aggregates in a query processing system.

### BACKGROUND

Cloud data platforms may be provided through a cloud data platform, which allows organizations, customers, and users to store, manage, and retrieve data from the cloud. With respect to type of data processing, a cloud data platform could implement online transactional processing, online analytical processing, a combination of the two, and/or other types of data processing. Moreover, a cloud data platform could be or include a relational database management system and/or one or more other types of database management systems.

Databases are used for data storage and access in computing applications. A goal of database storage is to provide enormous sums of information in an organized manner so that it can be accessed, managed, and updated. In a database, data may be organized into rows, columns, and tables. A database platform can have different databases managed by different users. The users may seek to share their database data with one another; however, it is difficult to share the database data in a secure and scalable manner.

### BRIEF DESCRIPTION OF THE DRAWINGS

Various ones of the appended drawings merely illustrate example embodiments of the present disclosure and should not be considered as limiting its scope.

FIG. 1 is a system diagram illustrating an example computing environment in which a cloud data platform can implement aggregation constraints, according to some example embodiments.

FIG. 2 is a block diagram illustrating components of a compute service manager, according to some example embodiments.

FIG. 3 is a block diagram illustrating components of an execution platform, according to some example embodiments.

FIG. 4A is a conceptual diagram illustrating aggregation policies, according to some example embodiments.

FIG. 4B is a chart illustrating a number of factors involved in determining what privacy level to choose, according to some example embodiments.

FIG. 5 is a chart illustrating data for displaying most watched programs, according to some example embodiments.

FIG. 6 is a chart illustrating data for displaying Company N's customers, according to some example embodiments.

FIG. 7 is a chart illustrating data displaying query results, according to some example embodiments.

FIG. 8 is a chart illustrating data for displaying query results with one customer removed, according to some example embodiments.

FIG. 9 is a chart illustrating data for displaying query results with noise and a chart of data for displaying query results with noise with one customer removed, according to some example embodiments.

FIG. 10 is a chart illustrating de-identified medical data, according to some example embodiments.

FIG. 11 is a conceptual diagram illustrating a Laplace probability density function, according to some example embodiments.

FIG. 12A is a graph depicting an example of a count query, according to some example embodiments.

FIG. 12B is a graph depicting an example of count averaged versus a number of samples, according to some example embodiments.

FIG. 12C is a graph depicting an example of a sum query, according to some example embodiments.

FIG. 12D is a graph depicting an example of sum averaged versus a number of samples, according to some example embodiments.

FIG. 12E is a graph depicting an example of a mean query, according to some example embodiments.

FIG. 12F is a graph depicting an example of an average averaged versus a number of samples, according to some example embodiments.

FIG. 13 is a flow diagram illustrating a method for assigning a specified noise level or aggregate, according to some example embodiments.

FIG. 14 is a block diagram illustrating components of a constraint aggregation system, according to some example embodiments.

FIG. 15A is a conceptual diagram illustrating a data sharing scenario in which a first provider shares data with one or more consumers, according to some example embodiments.

FIG. 15B is a conceptual diagram illustrating a two-party data sharing scenario for combining sensitive data, according to some example embodiments.

FIG. 15C is a conceptual diagram illustrating a data sharing scenario in which data shared by multiple providers is combined and shared with a consumer, according to some example embodiments.

FIG. 15D is a conceptual diagram illustrating a data sharing scenario including a first provider sharing data with one or more internal users, according to some example embodiments.

FIG. 16 is a flow diagram illustrating an example of database restrictions on access to database data, according to some example embodiments.

FIG. 17 is a conceptual diagram illustrating example sets of source data from different database accounts of a distributed database, according to some example embodiments.

FIG. 18A is an architecture diagram illustrating an example database architecture for implementing a defined-access clean room including a provider database account, according to some example embodiments.

FIG. 18B is an architecture diagram illustrating an example database architecture for implementing a defined-access clean room including a consumer database account, according to some example embodiments.

FIG. 19A is an architecture diagram illustrating an example database architecture for implementing query templates for multiple entities, according to some example embodiments.

FIG. 19B is an architecture diagram illustrating an example database architecture for implementing query templates for multiple entities sharing data in a data clean environment, according to some example embodiments.

FIG. 19C is an architecture diagram illustrating an example of data clean room architecture for sharing data between multiple parties, according to some example embodiments.

FIG. 20 is a block diagram illustrating a diagrammatic representation of a machine in the form of a computer system within which a set of instructions may be executed for causing the machine to perform any one or more of the methodologies discussed herein, according to some example embodiments.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail. For the purposes of this description, the phrase “cloud data platform” may be referred to as and used interchangeably with the phrases “a network-based database system,” “a database system,” or merely “a platform.”

Databases are used by various entities (e.g., businesses, people, organizations, etc.) to store data. For example, a retailer may store data describing purchases (e.g., product, date, price, etc.) and the purchasers (e.g., name, address, email address, etc.). Similarly, an advertiser may store data describing performance of their advertising campaigns, such as the advertisements served to users, date that advertisement was served, information about the user, (e.g., name, address, email address), and the like. In some cases, entities may wish to share their data with each other. For example, a retailer and advertiser may wish to share their data to determine the effectiveness of an advertisement campaign, such as by determining a fraction of users who saw the advertisement and subsequently purchased the product (e.g., determining a conversion rate of users that were served advertisements for a product and ultimately purchased the product). In these types of situations, the entities may wish to maintain the confidentiality of some or all of the data they have collected and stored in their respective databases. For example, a retailer and/or advertiser may wish to maintain the confidentiality of personal identifying information (PII), such as usernames, addresses, email addresses, credit card numbers, and the like.

Traditional approaches address this problem through prior solutions including heuristic anonymization techniques or differential privacy. For example, heuristic anonymization techniques (e.g., k-anonymity, l-diversity, and t-closeness) transform a dataset to remove identifying attributes from data. The anonymized data may then be freely analyzed, with limited risk that the analyst can determine the individual that any given row in a database (e.g., table) corresponds to. Differential privacy (DP) is a rigorous definition of what it means for query results to protect individual privacy. A typical solution that satisfies DP requires an analyst to perform an aggregate query and then adds random noise drawn from a Laplace or Gaussian distribution to the query result. Additional existing solutions include tokenization, which can only support exact matches of quality joins and often fails to protect privacy due to identity inference by other attributes. Existing systems have struggled to balance the sharing and collaboration of sensitive data without compromising privacy. Prior approaches, such as heuristic anonymization techniques and tokenization, aim to conceal identities by either removing specific data attributes or introducing noise into query results. Despite these efforts, challenges remain in maintaining data privacy against sophisticated attacks while ensuring the usability and accuracy of the shared data.

Existing methods fail to overcome such technical challenges for multiple reasons. For example, heuristic anonymization techniques can allow for data values in individual rows of a database to be seen, which increases a privacy risk (e.g., a risk potential of data exposure or the like); such techniques also require the removal or suppression of identifying and quasi-identifying attributes, as well as other attributes. This makes heuristic techniques like k-anonymity inappropriate for data sharing and collaboration scenarios, where identifying attributes are often needed to join datasets across entities (e.g., advertising). Further existing methods may not be accurate and cause usability issues and fail to provide grouping mechanisms per example embodiments of the present disclosure detailed throughout. Unlike prior approaches that rely on heuristic anonymization techniques and tokenization, which often compromise on accuracy and privacy, this system allows for the specification of aggregation constraints and the precise injection of noise into aggregated data results. Existing systems allow for data collaboration but fall short in adequately safeguarding Personally Identifiable Information (PII) against sophisticated attack vectors. Techniques like projection and aggregation constraints without the introduction of noise, as well as clean-room solutions, have been attempted. Yet, these approaches do not sufficiently mitigate the risks associated with differencing attacks or provide comprehensive privacy for sensitive attributes. This leaves a gap in ensuring the privacy and security of shared data under various attack scenarios.

Example embodiments of the present disclosure are directed to systems, methods, computer programs, and machine-readable storage mediums that include a noisy aggregates mechanism to allow sharing and collaboration of combined datasets from two or more different entities (e.g., two or more parties, two or more companies, two or more accounts, etc.) that contain sensitive information, such as PII, without explicitly leaking each other's sensitive information. In some examples, an organization may want to minimize the risk of exposing PII to internal teams as well, so the organization can apply projection and aggregation policies with noise on the table. The internal teams of the organization will be able to query the table, but only receive noisy aggregated results, which provides them with only what they need in order to accomplish their aims.

The noisy aggregates mechanism is applied to aggregation constraints to allow data providers (e.g., data steward, data owner, etc.) to specify restrictions on how their data can be used, in order to protect sensitive data from misuse. The aggregation constraints can be implemented in defined-access clean rooms to enable data providers to specify, in some examples via the provider's own code, what queries consumers can run on the data. Providers can offer flexibility via parameters and query templates, and the provider can control the vocabulary of the questions that can be asked; in this manner, the provider can review, adjust, change, modify, or otherwise control the aggregation constraint policy. The aggregation constraints can further be implemented as a type of query constraint that allow data providers to specify general restrictions on how the data can be used. The consumer can formulate the queries, and the platform (e.g., cloud data platform, database platform, on-premises platform, trusted data processing platform, and the like) ensures that these queries abide by the provider's requirements.

A cloud data platform can implement query constraints that allow customers to constrain what kind of queries can be run on constrained datasets. There are two types of constraints: projection constraints and aggregation constraints. Projection constraints allow customers to use a column in a query but do not allow that column to be projected in the result of the query. Aggregation constraints allow customers to constrain what aggregation functions can be used and a minimum group size that must be satisfied before returning the result. While these constraints (e.g., projection constraints and aggregation constraints) help avoid exposing information about individuals, these constraints still leave the dataset vulnerable to certain attacks. The primary attack is called a differencing attack, which is where the difference between two queries provides enough results to isolate a single individual among the data, thereby exposing PII.

Example embodiments of the present disclosure improve upon existing techniques and overcome such current technical challenges by providing noisy aggregates in a query processing system. Specifically, in order to prevent this type of differencing attack, example embodiments of the present disclosure inject noise to be added to the aggregated result. As a result, when an attacker attempts to differentiate queries, the attacker will not know whether they have or have not isolated an individual. For example, aggregation constraints place a threshold on the values returned by the aggregate function. Example embodiments of the present disclosure propose noisy aggregates to inject noise on top of the aggregation constraints to mitigate the risk for differentiating attacks.

Example embodiments further improve upon existing techniques by providing mitigation solutions over additional types of attacks; in addition to differentiating attacks, examples provide for defenses and solutions to amplification via enrichment attacks and membership inference via anti-joins attacks. In a differentiating attack, an attacker can compute the sum of all values and compute the sum of all values except for a specific person, then the attacker can subtract these two sums in order to get the values associated with the specific person. Example embodiments mitigate and protect against such a differentiating attack by implementing noisy aggregates to add noise to the result proportional to the range of values. In an amplification via enrichment attack, an attacker could join a sensitive attribute against a lookup table that computes an amplifying function. Example embodiments mitigate and protect against such an amplification attack by deriving specific ranges and applying the correct amount of noise based on the derived range. In a membership inference attack, an attacker can execute a differencing attack via an anti-join (instead of using a static filter). Example embodiments mitigate and overcome such a membership inference attack by implementing noisy aggregates.

Enforcing aggregation constraints on queries received at the cloud data platform including the injection of noisy aggregates allows for data to be shared and used by entities to extract insights, while blocking queries that target individual rows. Example embodiments include technical improvements over prior data sharing techniques by providing aggregation constraints plus noisy aggregates to entities to mitigate the risks of sensitive data exposure, where the aggregation constraints and noisy aggregates achieve this by enabling account administrators to specify noise with a new property of the cloud data platform's existing aggregation constraints. This will allow the account administrator to specify the noise for a particular table to which an aggregation constraint policy is attached, along with the existing minimum group size requirements that will allow the mitigation of the attacks specified above. By allowing noise specification with an aggregation policy, account administrators can control noise amount per entity (e.g., user, role, account, etc.) granularity by including the cloud data platform's various context functions in the policy expression.

Example embodiments include two components of noisy aggregates, including noise specification and noise injection to a query. Specifically, noise specification provides a mechanism to specify the amount of noise the user (e.g., customer) wants to specify for the aggregates of a table, and noise injection provides a mechanism to apply the user-specified noise to the aggregate functions of a user query on the table at runtime. By providing noisy aggregates to customers of a cloud data platform, customers can have additional privacy in the form of increasing the complexity for attackers and thereby reducing the probability of a privacy leak.

Example embodiments of the present disclosure include an aggregation constraint system including an overlapping noisy aggregate mechanism. Specifically, aggregation constraints that specify minimum group size requirements for an aggregate and adding noise to that feature can ensure better privacy. It also shares the similar expressiveness, privilege model, and policy framework as the aggregation constraints. In addition, example embodiments disclose an aggregation system incorporating noisy aggregates that can provide aggregation constraints to mitigate against analysts inferring anything about the values of sensitive attributes in individual rows of the table. Aggregation constraints can be used alone or in combination with clean room systems, along with additional query constraints, such as projection constraints.

Examples effectively counter differencing attacks, amplification via enrichment, and membership inference attacks, thereby facilitating secure data sharing and collaboration without compromising sensitive data. Examples uniquely combine aggregation constraints with noise injection to offer a more accurate and secure method for data privacy. For example, by enabling data providers to control aggregation constraints and noise levels, the system promotes enhanced privacy protection against various types of attacks, supporting more secure data management and sharing on cloud data platforms. In some examples, the use of a Laplace mechanism for noise generation and the ability to reject queries attempting direct access to sensitive information further distinguish this system from existing solutions, providing a tailored approach to privacy preservation tailored to the data's sensitivity and the context of queries.

Some examples manage privacy in data sharing contexts, particularly within a cloud data platform environment. Some examples include several key components (e.g., modules, circuits, sub-systems, etc.) designed to work in concert to protect sensitive data while enabling collaboration and data analysis among multiple parties. A query processing component is provided to handle incoming queries directed at datasets shared within the cloud platform. To ensure that the privacy of sensitive data is maintained, an aggregation constraint component is provided to handle and/or apply specific constraints to designated tables within these datasets. These constraints limit the output of data values based on the context in which the queries are received, preventing direct access to sensitive information. To further privacy protection, a noise injection component is provided to introduce a specified amount of noise into the aggregated query results. This noise is determined based on the aggregation constraints previously applied and serves to obscure the precise values of the data, thereby preserving the privacy of the data subjects. This mechanism is uniquely important in scenarios where aggregated data might still reveal sensitive information about individuals within the dataset.

In some examples, the noise introduced is calculated using a Laplace mechanism, ensuring that the privacy enhancements adhere to the principles of differential privacy. The system also includes a data sharing component provided to enable secure sharing of aggregated and noise-augmented data among multiple parties. Examples of the data sharing component facilitate data collaboration without exposing sensitive information, allowing for collective data analysis within defined-access clean rooms. These clean rooms allow for the combination of data from multiple providers, subject to the established aggregation constraints and noise injection protocols. A policy management component is provided to handle data providers with the tools to specify the constraints under which their data can be shared and analyzed. For example, this can include determining the minimum group size for aggregated results to prevent the identification of individual data entries, a critical feature for maintaining privacy. Providers can also specify the amount of noise to be injected into the aggregated results, offering control over the degree of privacy preservation applied to their data.

Examples of the system are designed with flexibility, allowing for the dynamic adjustment of the minimum group size based on the sensitivity of the data being aggregated. This ensures that privacy protections can be tailored to the specific needs of the data and the data-sharing scenario. Additionally, the system's noise injection capabilities are parameterized to account for varying sensitivities across different types of data within the shared dataset. Examples of the system provide a robust framework for privacy-preserving data sharing and analysis, enabling data providers to maintain control over their data while participating in collaborative research and analysis efforts.

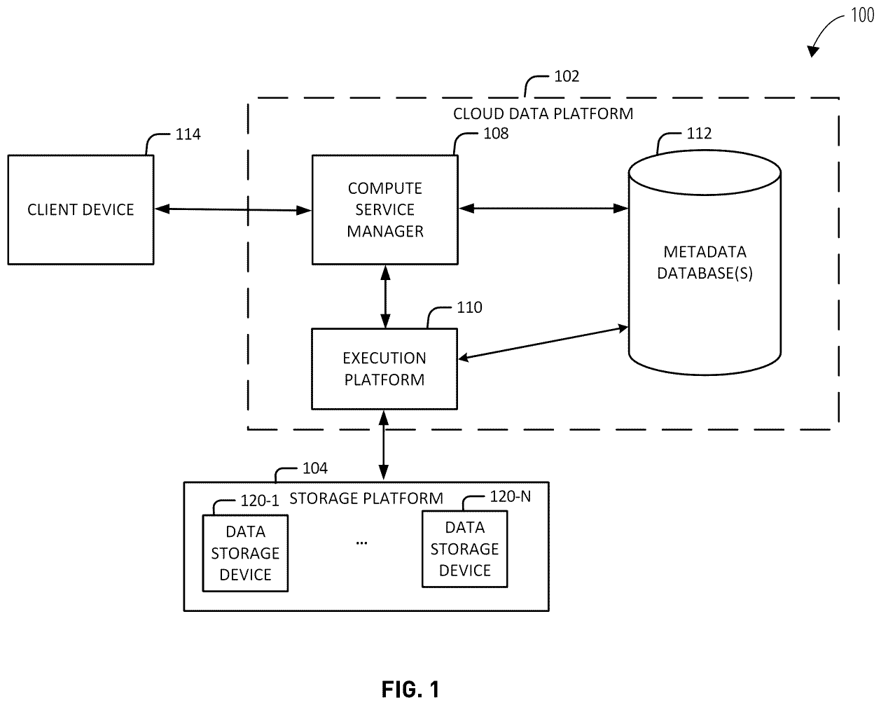

FIG. 1 illustrates an example computing environment 100 in which a cloud data platform 102 can implement aggregation constraints, according to some example embodiments. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein. In other embodiments, the computing environment may comprise another type of network-based database system or a cloud data platform.

As shown, the computing environment 100 comprises the cloud data platform 102 in communication with a cloud storage platform 104 (e.g., AWS®, Microsoft Azure Blob Storage®, or Google Cloud Storage). The cloud data platform 102 is a network-based system used for reporting and analysis of integrated data from one or more disparate sources including one or more storage locations within the cloud storage platform 104. The cloud storage platform 104 comprises a plurality of computing machines and provides on-demand computer system resources such as data storage and computing power to the cloud data platform 102.

The cloud data platform 102 comprises a compute service manager 108, an execution platform 110, and one or more metadata databases 112. The cloud data platform 102 hosts and provides data reporting and analysis services to multiple client accounts.

The compute service manager 108 coordinates and manages operations of the cloud data platform 102. The compute service manager 108 also performs query optimization and compilation as well as managing clusters of computing services that provide compute resources (also referred to as “virtual warehouses”). The compute service manager 108 can support any number of client accounts, such as end-users providing data storage and retrieval requests, system administrators managing the systems and methods described herein, and other components/devices that interact with compute service manager 108.

The compute service manager 108 is also in communication with a client device 114. The client device 114 corresponds to a user of one of the multiple client accounts supported by the cloud data platform 102. A user may utilize the client device 114 to submit data storage, retrieval, and analysis requests to the compute service manager 108.

The compute service manager 108 is also coupled to one or more metadata databases 112 that store metadata pertaining to various functions and aspects associated with the cloud data platform 102 and its users. For example, metadata database(s) 112 may include a summary of data stored in remote data storage systems as well as data available from a local cache. Additionally, metadata database(s) 112 may include information regarding how data is partitioned and organized in remote data storage systems (e.g., the cloud storage platform 104) and local caches. As discussed herein, a “micro-partition” is a batch storage unit, and each micro-partition has contiguous units of storage. By way of example, each micro-partition may contain between 50 MB and 500 MB of uncompressed data (note that the actual size in storage may be smaller because data may be stored compressed). Groups of rows in tables may be mapped into individual micro-partitions organized in a columnar fashion. This size and structure allow for extremely granular selection of the micro-partitions to be scanned, which can be comprised of millions, or even hundreds of millions, of micro-partitions. This granular selection process for micro-partitions to be scanned is referred to herein as “pruning.”

Pruning involves using metadata to determine which portions of a table, including which micro-partitions or micro-partition groupings in the table, are not pertinent to a query, avoiding those non-pertinent micro-partitions when responding to the query, and scanning only the pertinent micro-partitions to respond to the query. Metadata may be automatically gathered on all rows stored in a micro-partition, including the range of values for each of the columns in the micro-partition; the number of distinct values; and/or additional properties used for both optimization and efficient query processing. In one embodiment, micro-partitioning may be automatically performed on all tables. For example, tables may be transparently partitioned using the ordering that occurs when the data is inserted/loaded. However, it should be appreciated that this disclosure of the micro-partition is exemplary only and should be considered non-limiting. It should be appreciated that the micro-partition may include other database storage devices without departing from the scope of the disclosure. Information stored by a metadata database 112 (e.g., key-value pair data store) allows systems and services to determine whether a piece of data (e.g., a given partition) needs to be accessed without loading or accessing the actual data from a storage device.

The compute service manager 108 is further coupled to the execution platform 110, which provides multiple computing resources that execute various data storage and data retrieval tasks. The execution platform 110 is coupled to cloud storage platform 104. The cloud storage platform 104 comprises multiple data storage devices 120-1 to 120-N. In some embodiments, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid state drives (SSDs), storage clusters, Amazon S3™ storage systems, or any other data storage technology. Additionally, the cloud storage platform 104 may include distributed file systems (such as Hadoop Distributed File Systems (HDFS)), object storage systems, and the like.

The execution platform 110 comprises a plurality of compute nodes. A set of processes on a compute node executes a query plan compiled by the compute service manager 108. The set of processes can include: a first process to execute the query plan; a second process to monitor and delete cache files using a least recently used (LRU) policy and implement an out of memory (OOM) error mitigation process; a third process that extracts health information from process logs and status to send back to the compute service manager 108; a fourth process to establish communication with the compute service manager 108 after a system boot; and a fifth process to handle all communication with a compute cluster for a given job provided by the compute service manager 108 and to communicate information back to the compute service manager 108 and other compute nodes of the execution platform 110.

In some embodiments, communication links between elements of the computing environment 100 are implemented via one or more data communication networks. These data communication networks may utilize any communication protocol and any type of communication medium. In some embodiments, the data communication networks are a combination of two or more data communication networks (or sub-networks) coupled to one another. In alternate embodiments, these communication links are implemented using any type of communication medium and any communication protocol.

The compute service manager 108, metadata database(s) 112, execution platform 110, and cloud storage platform 104 are shown in FIG. 1 as individual discrete components. However, each of the compute service managers 108, metadata databases 112, execution platforms 110, and cloud storage platforms 104 may be implemented as a distributed system (e.g., distributed across multiple systems/platforms at multiple geographic locations). Additionally, each of the compute service managers 108, metadata databases 112, execution platforms 110, and cloud storage platforms 104 can be scaled up or down (independently of one another) depending on changes to the requests received and the changing needs of the cloud data platform 102. Thus, in the described embodiments, the cloud data platform 102 is dynamic and supports regular changes to meet the current data processing needs.

During typical operation, the cloud data platform 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in a metadata database 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the cloud storage platform 104. It is desirable to retrieve as much data as possible from caches within the execution platform 110 because the retrieval speed is typically much faster than retrieving data from the cloud storage platform 104.

As shown in FIG. 1, the computing environment 100 separates the execution platform 110 from the cloud storage platform 104. In this arrangement, the processing resources and cache resources in the execution platform 110 operate independently of the data storage devices 120-1 to 120-N in the cloud storage platform 104. Thus, the computing resources and cache resources are not restricted to specific data storage devices 120-1 to 120-N. Instead, all computing resources and all cache resources may retrieve data from, and store data to, any of the data storage resources in the cloud storage platform 104.

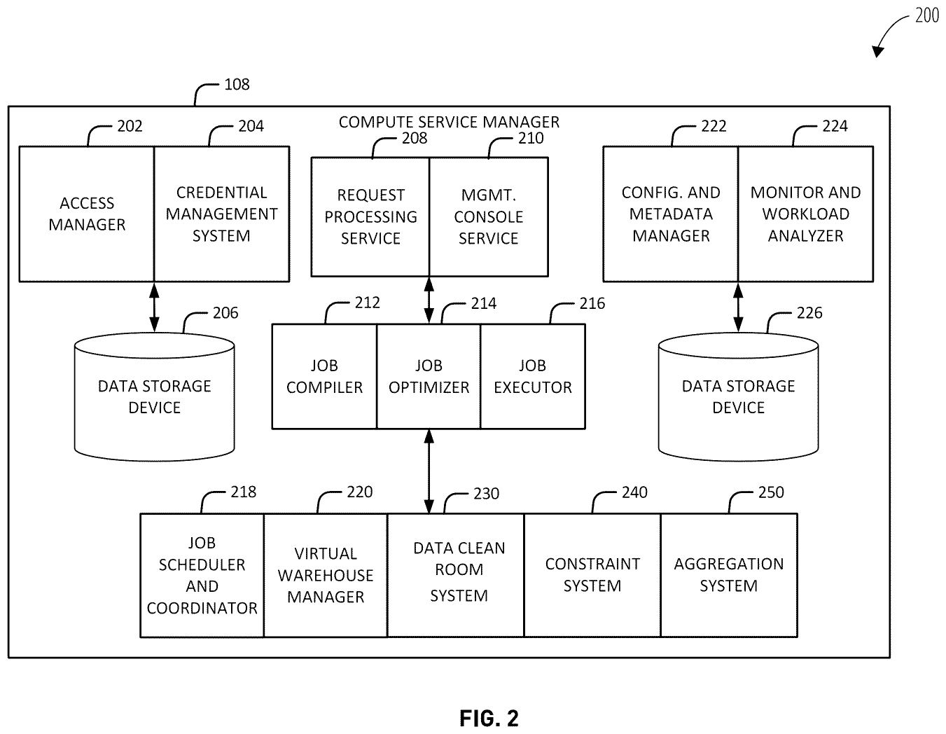

FIG. 2 is a block diagram 200 illustrating components of the compute service manager 108, in accordance with some embodiments of the present disclosure. As shown in FIG. 2, the compute service manager 108 includes an access manager 202 and a credential management system 204 coupled to data storage device 206, which is an example of the metadata databases 112. Access manager 202 handles authentication and authorization tasks for the systems described herein.

The credential management system 204 facilitates use of remote stored credentials to access external resources such as data resources in a remote storage device. As used herein, the remote storage devices may also be referred to as “persistent storage devices” or “shared storage devices.” For example, the credential management system 204 may create and maintain remote credential store definitions and credential objects (e.g., in the data storage device 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 204 and access manager 202 use information stored in the data storage device 206 (e.g., access metadata database, a credential object, and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110 or in a data storage device in cloud storage platform 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110 of FIG. 1. For example, jobs may be prioritized and then processed in the prioritized order. In an embodiment, the job scheduler and coordinator 218 determines a priority for internal jobs that are scheduled by the compute service manager 108 of FIG. 1 with other “outside” jobs such as user queries that may be scheduled by other systems in the database but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries, requests, or the like.

As illustrated, the compute service manager 108 includes a configuration and metadata manager 222, which manages the information related to the data stored in the remote data storage devices and in the local buffers (e.g., the buffers in execution platform 110). The configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the cloud data platform 102 and may further redistribute tasks based on a user (e.g., “external”) query workload that may also be processed by the execution platform 110. The configuration and metadata manager 222 and the monitor and workload analyzer 224 are coupled to a data storage device 226. Data storage device 226 represents any data storage device within the cloud data platform 102. For example, data storage device 226 may represent buffers in execution platform 110, storage devices in cloud storage platform 104, or any other storage device.

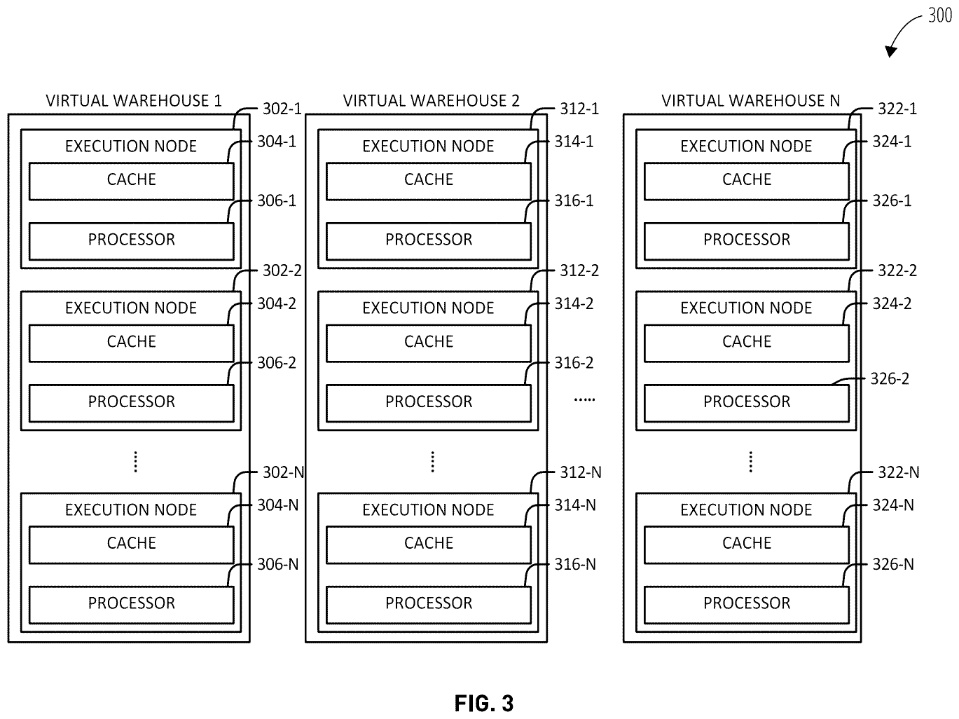

As described in embodiments herein, the compute service manager 108 validates all communication from an execution platform (e.g., the execution platform 110) to validate that the content and context of that communication are consistent with the task(s) known to be assigned to the execution platform. For example, an instance of the execution platform executing a query A should not be allowed to request access to data-source D (e.g., data storage device 226) that is not relevant to query A. Similarly, a given execution node (e.g., execution node 302-1 of FIG. 3) may need to communicate with another execution node (e.g., execution node 302-2 of FIG. 3), but should be disallowed from communicating with a third execution node (e.g., execution node 312-1), and any such illicit communication can be recorded (e.g., in a log or other location). Also, the information stored on a given execution node is restricted to data relevant to the current query, and any other data is unusable, rendered so by destruction or encryption where the key is unavailable.

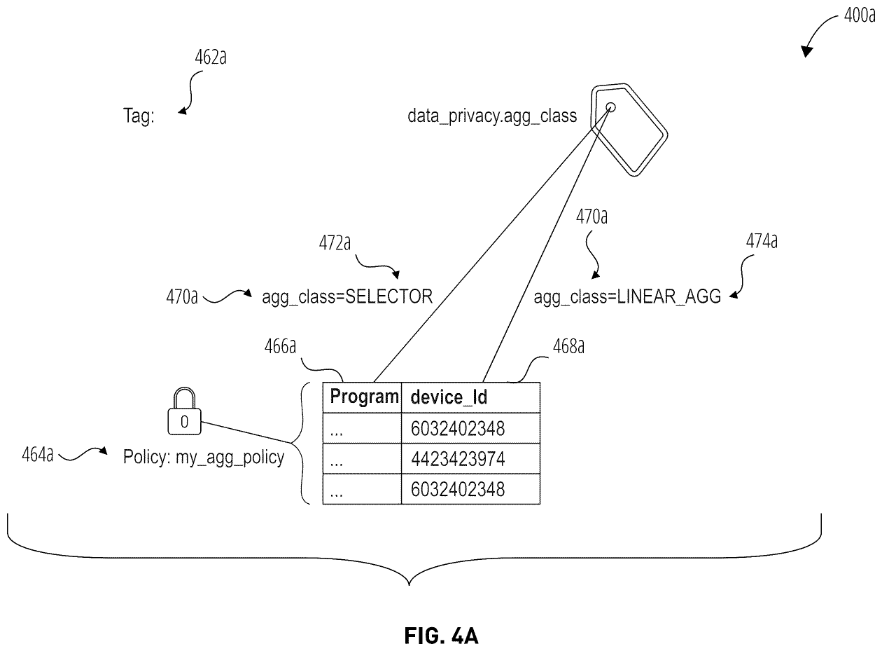

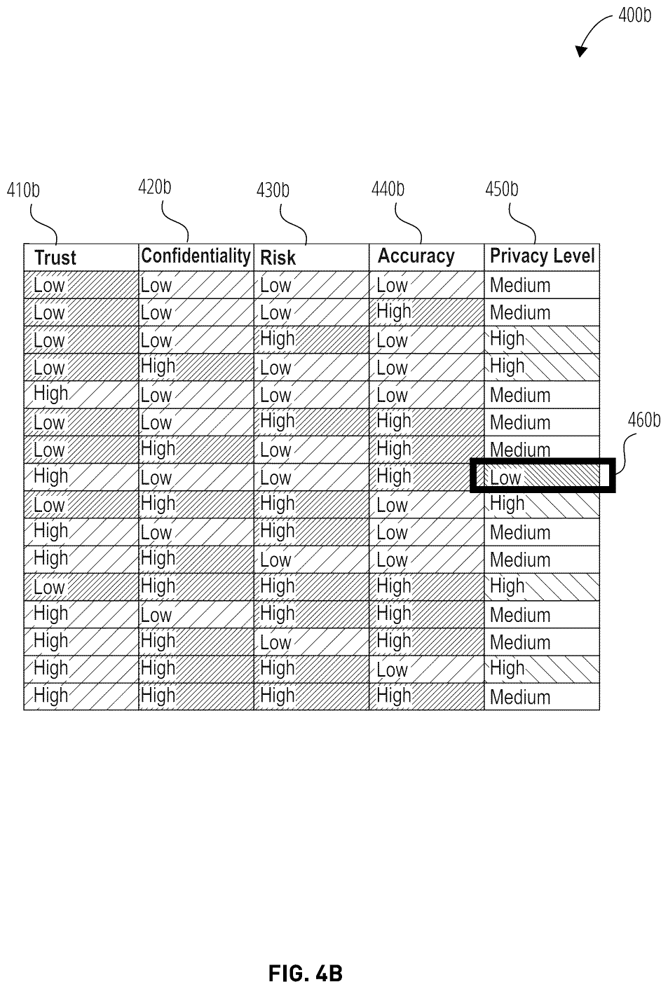

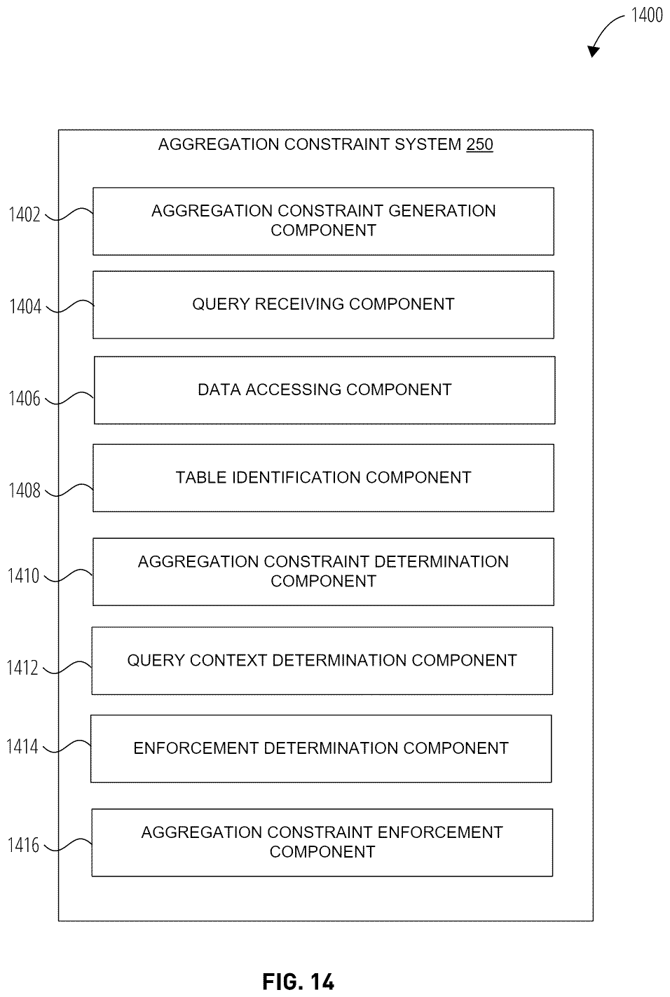

The data clean room system 230 allows for dynamically restricted data access to shared datasets, as depicted and described in further detail below with in connection with FIGS. 4A and 4B, FIG. 9, FIG. 11, FIG. 14, FIG. 16, and FIGS. 18A-18B. The constraint system 240 provides for projection constraints on data values stored in specified columns of shared datasets, as discussed in further detail below. An aggregation system 250 can be implemented within the cloud data platform 102 when processing queries directed to tables in shared datasets. The aggregation system 250 (also referred to as the aggregation constraint system) is described in detail in connection with FIG. 14. For example, in some embodiments, the aggregation system 250 can be implemented within a clean room provided by the data clean room system 230, the constraint system 240, and/or in conjunction with the aggregation system 250.

As used herein, aggregation constraints, such as aggregation constraint policies, can comprise (or refer to) a policy, rule, guideline, or combination thereof or, rule for limiting, for example, the ways that data can be aggregated or restricting to only aggregate data in specific ways according to a data provider's determinations (e.g., policies). For example, aggregation constraints enable use of providing restrictions, limitations, or other forms of data provider control over the aggregated data for purposes of queries and return responses to queries. An aggregation constraint can include criteria or dimension on what data in a shared dataset can be grouped together based on defined or provided operations (e.g., functions) applied to the data in each group. Aggregation constraints enable customers and users to analyze, share, collaborate, and combine datasets containing sensitive information while mitigating risks of exposing the sensitive information, where aggregation can include the grouping and/or combining of data to obtain summary information (e.g., minimum, totals, counts, averages, etc.). An aggregation constraint can identify that the data in a table should be restricted from being aggregated using functions such as AVG, COUNT, MIN, MAX, SUM, and the like to calculate aggregated values based on groups of data. For example, the inputs do not skew or amplify specific values in a way that might create privacy challenges), and they do not reveal specific values in the input.

The constraint system 240 enables entities to establish projection constraints (e.g., projection constraint policies) to shared datasets. A shared dataset can include a collection of data that is made available to multiple users or systems. In the context of privacy preservation, a shared dataset is one that is accessible by different parties who may have varying levels of permission to view, modify, or analyze the data. The dataset is “shared” in the sense that it is not exclusive to a single user or system, and therefore requires privacy controls to ensure that data sharing does not compromise the confidentiality or integrity of the data.

A projection constraint identifies that the data in a column may be restricted from being projected (e.g., presented, read, outputted) in an output to a received query, while allowing specified operations to be performed on the data and a corresponding output to be provided. For example, the projection constraint may indicate a context for a query that triggers the constraint, such as based on the user that submitted the query.

For example, the constraint system 240 may provide a user interface or other means of communication that allows entities to define projection constraints in relation to their data that is maintained and managed by the cloud data platform 102. To define a projection constraint, the constraint system 240 enables users to provide data defining the shared datasets and columns to which a projection constraint should be attached. For example, a user may submit data defining a specific column and/or a group of columns within a shared dataset that should be attached with the projection constraint.

Further, the constraint system 240 enables users to define conditions for triggering the projection constraint. This may include defining the specific context and/or contexts that triggers enforcement of the projection constraint. For example, the constraint system 240 may enable users to define roles of users, accounts and/or shares, which would trigger the projection constraint and/or are enabled to project the constrained column of data. After receiving data defining a projection constraint, the constraint system 240 generates a file that is attached to the identified columns. In some embodiments, the file may include a Boolean function based on the provided conditions for the projection constraint. For example, the Boolean function may provide an output of true if the projection constraint should be enforced in relation to a query and an output of false if the projection constraint should not be enforced in relation to a query. Attaching the file to the column establishes the projection constraint to the column of data for subsequent queries.

The constraint system 240 receives a query directed to a shared dataset. The query may include data defining data to be accessed and one or more operations to perform on the data. The operations may include any type of operations used in relation to data maintained by the cloud data platform 102, such as join operation, read operation, and the like. The constraint system 240 may provide data associated with the query to the other components of the constraint system 240, such as a data accessing component, a query context determination component, or other components of the constraint system 240. The constraint system 240 accesses a set of data based on a query received by the constraint system 240 or a component thereof. For example, the data accessing component may access data from columns and/or sub-columns of the shared dataset that are identified by the query and/or are needed to generate an output based on the received query. The constraint system 240 may provide the accessed data to other components of the constraint system 240, such as a projection constraint enforcement component. The constraint system 240 determines the columns associated with the data accessed by the constraint system 240 in response to a query. This can include columns and/or sub-columns from which the data was accessed. The constraint system 240 may provide data identifying the columns to the other components of the constraint system 240, such as a projection constraint determination component.

The constraint system 240 determines whether a projection constraint (e.g., projection constraint policy) is attached to any of the columns identified by the constraint system 240. For example, the constraint system 240 determines whether a file defining a projection constraint is attached to any of the columns and/or sub-columns identified by the constraint system 240. The constraint system 240 may provide data indicating whether a projection constraint is attached to any of the columns and/or the file defining the projection constraints to the other components of the constraint system 240, such as an enforcement determination component.

The constraint system 240 determines a context associated with a received query. For example, the constraint system 240 may use data associated with a received query to determine the context, such as by determining the role of the user that submitted the query, an account of the cloud data platform 102 associated with the submitted query, a data share associated with the query, and the like. The constraint system 240 may provide data defining the determined context of the query to the other components of the constraint system 240, such as an enforcement determination component.

The constraint system 240 determines whether a projection constraint should be enforced in relation to a received query. For example, the constraint system 240 uses the data received that indicates whether a projection constraint is attached to any of the columns and/or the file defining the projection constraints as well as the context of the query received from the constraint system 240 to determine whether a projection constraint should be enforced. If a query constraint is not attached to any of the columns, the constraint system 240 determines that a projection constraint should not be enforced in relation to the query. Alternatively, if a projection constraint is attached to one of the columns, the constraint system 240 uses the context of the query to determine whether the projection constraint should be enforced. For example, the constraint system 240 may use the context of the query to determine whether the conditions defined in the file attached to the column are satisfied to trigger the projection constraint. In some embodiments, the constraint system 240 may use the context of the query as an input into the Boolean function defined by the projection constraint to determine whether the projection constraint is triggered. For example, if the Boolean function returns a true value, the constraint system 240 determines that the projection constraint should be enforced. Alternatively, if the Boolean function returns a false value, the constraint system 240 determines that the projection constraint should not be enforced. The constraint system 240 may provide data indicating whether the projection constraint should be enforced to the other components of the constraint system 240, such as a projection constraint enforcement component.

The constraint system 240 enforces a projection constraint in relation to a query. For example, the constraint system 240 may prohibit an output to a query from including data values from any constrained columns of a shared dataset. This may include denying a query altogether based on the operations included in the query, such as if the query requests to simply output the values of a constrained column. However, the constraint system 240 may allow for many other operations to be performed while maintaining the confidentiality of the data values in the restricted columns, thereby allowing for additional functionality compared to current solutions (e.g., tokenization). For example, the constraint system 240 allows for operations that provide an output indicating a number of data values within a column that match a specified key value or values from another column, including fuzzy matches. As one example, two tables can be joined on a projection-constrained column using a case-insensitive or approximate match. Tokenization solutions are generally not suitable for these purposes.

The constraint system 240 may also allow users to filter and perform other operations on data values stored in projection-constrained columns. For example, if an email-address column is projection-constrained, an analyst end-user is prevented from enumerating all of the email addresses but can be allowed to count the number of rows for which the predicate “ENDSWITH (email, ‘database_123’)” is true. The constraint system 240 may provide an output to the query to a requesting user's client device.

However, the constraint system 240, cannot protect individual privacy with projection constraints by themselves; enumeration attacks are possible, aggregate queries on non-constrained attributes are possible, and covert channels are possible.

FIG. 3 is a block diagram 300 illustrating components of the execution platform 110 of FIG. 1, in accordance with some embodiments of the present disclosure.

As shown in FIG. 3, the execution platform 110 includes multiple virtual warehouses, including virtual warehouse 1, virtual warehouse 2, and virtual warehouse N. Each virtual warehouse includes multiple execution nodes that each include a data cache and a processor. The virtual warehouses can execute multiple tasks in parallel by using the multiple execution nodes. As discussed herein, the execution platform 110 can add new virtual warehouses and drop existing virtual warehouses in real-time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in cloud storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer useful.

Each virtual warehouse is capable of accessing any of the data storage devices 120-1 to 120-N shown in FIG. 1. Thus, the virtual warehouses are not necessarily assigned to a specific data storage device 120-1 to 120-N and, instead, can access data from any of the data storage devices 120-1 to 120-N within the cloud storage platform 104. Similarly, each of the execution nodes shown in FIG. 3 can access data from any of the data storage devices 120-1 to 120-N. In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data being cached by the execution nodes. For example, these execution nodes do not store or otherwise maintain state information about the execution node, or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each include one data cache and one processor, alternate embodiments may include execution nodes containing any number of processors and any number of caches. Additionally, the caches may vary in size among the different execution nodes. The caches shown in FIG. 3 store, in the local execution node, data that was retrieved from one or more data storage devices in cloud storage platform 104 of FIG. 1. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet, another execution node may contain cache resources providing faster input-output operations, useful for tasks that require fast scanning of large amounts of data. In some embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor intensive. Similarly, an execution node may be assigned more cache resources if the tasks performed by the execution node require a larger cache capacity.

Although virtual warehouses 1, 2, and N are associated with the same execution platform 110, the virtual warehouses may be implemented using multiple computing systems at multiple geographic locations. For example, virtual warehouse 1 can be implemented by a computing system at a first geographic location, while virtual warehouses 2 and N are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location and implements execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault tolerant. For example, if one virtual warehouse fails, that virtual warehouse is quickly replaced with a different virtual warehouse at a different geographic location. A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer useful.

In some embodiments, the virtual warehouses may operate on the same data in cloud storage platform 104, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance.

FIG. 4A is an illustration of an aggregation policy 400a specifying allowed aggregate functions, according to some example embodiments.

Providers of the cloud data platform 102 can specify allowed aggregate classes using a system tag 462a according to some example embodiments. For example, the “program” column 466a can be used as a grouping key and the “device_ID” column 468a can be used with linear aggregation 474a functions (e.g., COUNT, DISTINCT).

In some example embodiments, users (e.g., customers of the cloud data platform) can specify allowed aggregate operators on a per-column basis. Since aggregation policies are attached at the table level, this property is not part of the policy itself. Instead, a system tag 462a is used, data_privacy.agg_class, to specify the allowed class for each column. Tag-based policies, alone or in combination with support for tag propagation, can provide a way to ensure that when users derive data from sensitive data (e.g., through a view, CTAS, etc.), the derived data can inherit the policy protections of the source data.

In some example embodiments, the granularity of aggregation constraints and/or aggregate classes can be specified or changed. For example, aggregation constraints are specified at the table level, while the classes are specified via tags at the column level. In such example embodiments, the user has a table where each row contains sensitive data about an individual. All queries about those individuals can be aggregated to protect individual privacy. The aggregation class 470a can be a property of the data type, such as a selector 472a. In alternative example embodiments, each column can have its own aggregation constraint, where aggregation is enforced depending on which columns are accessed in the query. Aggregation constraints can be expressed at the column level (opposed to the table level or other schema level) using policies, such as policy 464a. For example, different aggregate function classes for different consumers can be applied and different minimum group sizes can be applied depending on which attributes are selected. When an aggregation constraint is attached to a view: the constraint will be enforced for queries that access that view column, but not for queries that access the underlying table(s) directly if it is not aggregation constrained. A view will be aggregation constraint protected if the underlying source table is also aggregation constrained.

In some example embodiments, an aggregation policy can be set on a view, regardless of the source table(s) being aggregation constrained or not. When there are multiple levels of aggregation constraint, the most restrictive (e.g., largest) min_group_size is selected and applied on the first level aggregate so that the data is most protected. Consider a query Q ran against a view ‘foo_v’ whose source table is ‘foo’: If view ‘foo_v’ and table ‘v’ both have aggregation policy set, with min_group_size=>50 for ‘foo_v’ and 10 for ‘v’, the most restrictive (largest) min_group_size will be chosen to be applied to the first level aggregate. Table policy will only be applied to the first level aggregate (e.g., if the view definition has an aggregate) the policy on ‘foo’ will be applied to it and the next level aggregate Q will not have the policy applied. If the view has a policy, the view policy will be applied to the Q, the top-level aggregate. If the view definition does not have aggregate, the policy will be applied to Q, the top-level aggregate. If the view also has a policy, the most restrictive one (between ‘foo_v’ and ‘foo’) is selected.

An aggregation policy can be a rule or set of rules and guidelines that determine how data is collected, processed, and/or presented as results. For example, an aggregation policy can define criteria for grouping data into meaningful categories, customer segments, time intervals, and the like. The aggregation policy can further specify how individual data points within each category are combined, such as summing, counting, and/or averaging.

According to example embodiments, aggregation policies can specify a variety of characteristics and properties related to noisy aggregates. For example, an aggregation policy can specify how noise is identified as a property of an aggregation constraint, where the property is called noise_amount. Noise can include a perturbation that is added to the true answer but is not part of it. For example, it is generated by sampling from a probability density function that has zero mean and a standard deviation that is related to the size of the perturbation desired taking into account the type of aggregation and the dataset size.

```
::::::CODE::::::
CREATE AGGREGATION POLICY
    my_policy_with_noise AS ( ) returns aggregation_config −>
    CASE
      WHEN current_account( ) = ‘MY_ACCOUNT’
  THEN aggregation_constraint(min_group_size => 0)
      WHEN current_account( ) = ‘SEMI_TRUSTED_PARTNER’
        THEN aggregation_constraint(min_group_size => 50,
    noise_amount => <amount>)
      ELSE aggregation_constraint(min_group_size => 500,
    noise_amount => <amount>)
    END;
::::::CODE::::::
```

Based on this example code, any table that has the above aggregation policy will include the specified noise in the runtime. For example, a table customers can be assigned to the policy, my_policy_with_noise, using the following syntax: ALTER TABLE customers SET AGGREGATION POLICY my_policy_with_noise. Thereby taking advantage of the aggregation policy framework, without having to consider aggregation policies and noisy aggregates separately.

In some example embodiments, a system function and special syntax to specify the noise at query time can be implemented. For example, a new function SYSTEMSNOISE_AMOUNT(<amount>) can be introduced, with the following syntax to show that the user counts the email column of a table customers by injecting 5% noise: SELECT WITH SYSTEM$NOISE_AMOUNT(5) COUNT (email) FROM customers. In some example embodiments, a modified noisy version of the aggregates that also accepts a noise amount as an additional argument is provided. For example, the following query adds 5% noise when performing a count on a customer's table: SELECT NOISY COUNT(5, email) FROM customers. These example approaches include a lightweight mechanism that is a good fit for the defined access model where the provider account provides the SQL expression.

In some example embodiments, the cloud data platform allows users to specify the amount of noise to be applied using noisy aggregates. Noise can be specified as a cloud data platform defined qualitative property (e.g., LOW, MEDIUM, HIGH) that internally maps to a percentage of noise (e.g., LOW is 3% noise, MEDIUM is 5% noise, HIGH is 10% noise). For example: A noise level LOW is specified as follows: aggregation_constraint(noise_amount=>‘LOW’). This example provides that qualitative values are like a privacy profile where the customers do not think of numerical noise calculation. In addition, the cloud data platform can publish guidelines that help users to select a privacy profile.

In another example embodiment, noise can be specified as a numerical percentage (e.g., 3%). For example: aggregation_constraint (noise_amount=>3). In this example, a user can pick any amount they want, (e.g., 2%, 100%). In some example embodiments, the relation between min_group_size and noise_amount can be categorized or stated as being disproportionate where a big min_group_size will require less amount of noise.

FIG. 4B is a table 400b including a number of factors involved in determining what privacy level to choose, in accordance with some example embodiments.

An embodiment of the present disclosure relates to an automated privacy level assessment system that utilizes machine learning to determine the appropriate privacy level for data shared within a cloud data platform. The system analyzes factors such as trust level with partners, data confidentiality, disclosure risk, and required accuracy. Based on these factors, the system assigns a privacy level that dictates the amount of noise to be injected into query results to protect sensitive information. For example, the privacy level can be a predefined setting or classification within a data management system that specifics the strictness of privacy controls applied to a dataset. The privacy level may be based on various factors, such as the sensitivity of the data, regulatory requirements, or user preferences. It typically dictates the extent to which personal or sensitive information is protected from exposure or unauthorized access.

The factors associated with privacy level 450b determination can include, for example, trust 410b, confidentiality 420b, risk 430b, and accuracy 440b; however, it will be understood that additional privacy determination factors can be added or removed. The noise amount can have a number of possible values; however, for simplicity, example embodiments describe three possible noise amount values, for example: (1) Low=3% noise, (2) Medium=5% noise, and (3) High=10% noise. Although it will be understood by those having ordinary skill in the art that more or fewer noise amount values can be similarly implemented according to examples of the present invention.

In the table 400b, there are a number of factors that can be involved when determining what privacy level or profile to select. For example, partner trust 410b can include levels or categories of the factor such as known partner that the provider has worked with previously, a contract is in place that specifies that the partner will not attempt to re-identify individuals in the providers data, the partner has not been breached, the partner has security and governance in place, and other such categories. Related to the data confidentiality 420b factor, an assessment by the provider of the amount of damage that could be caused if there was a breach.

Related to the disclosure risk 430b factor, there is a probability of estimation or guessing that can be performed. For example, the policy can include Visualizing Privacy (ViP) to dynamically update visualizations depicting expected accuracy and risk and define this as measured by the upper bound on the probability of an attacker correctly guessing the absence/presence of a record in a computation after seeing the result. This can be computed as follows:

$$risk = {( 1 + ( n - 1 ) {e}^{\frac{- ∈}{{Δ}_{f}}} )}^{- 1}$$

### Example Algorithm for Depicting Expected Accuracy and Risk from Visualizing Privacy-Utility Trade-Offs in Differentially Private Data Releases

Where n is the number of records. In such an example, the provider can specify the acceptable risk or probability of the partner accurately guessing. An embodiment of the present disclosure includes an interactive data visualization tool that integrates visual noise indicators. The tool allows users to visualize how noise affects the accuracy and privacy of aggregated data results, such as the most-watched programs by customers of a company. The tool provides real-time feedback on the visual representation of data as the noise level is adjusted, enhancing user understanding of the privacy-accuracy trade-off.

Related to the accuracy 440b factor, the provider can ascertain, based on what the necessary level of accuracy is needed by their consumers. When evaluating the privacy factors, it is helpful to assign levels or magnitudes of something in comparison relative to some standard or reference point. For example, using “high” and “low” can help describe a level of risk based on a likelihood and potential impact of a particular event or outcome, such as assigning high or low to each factor in the table 400b and then using the table 400b to assign a privacy level. These levels can be recommended minimums, for example. The different patterns (e.g., hatch marks) represent when a level has a possibility of more risk: high risk, medium risk, and low risk.

For example, looking at the first line of the table 400b, at the first line: Partner trust 410b is low, which means this is a new partner, the partner has recently suffered a breach, the partner does not have a high level of security and governance, or there is not a contract in place; therefore, this indicates a higher risk. Data confidentiality 420b is low, which means that a disclosure of the data does not contain overly sensitive information; therefore, this indicates a lower risk. Disclosure risk 430b is low, which means that the probability that the partner can reidentify someone in the data is low; therefore, this indicates a lower risk. This could be because the attributes being shared are not well known or are not identifying which would correlate with the previous category. Accuracy 440b is low, which means that a high level of noise would be acceptable to the partner; therefore, this indicates a lower risk. Based on these factors, and because partner trust is low, the example embodiment in line one of table 400b should identify the privacy level 460b as being Set to a Minimum Level of Medium.

While the example table 400b illustrates how a table gets a noise amount from the associated aggregation policy, some example embodiments describe how the noise can interact with a query that aggregates the table. For example, there can be additional options for query syntax and/or how a query can aggregate such an aggregation policy protected table.

According to a first example, mandatory noise injection to the aggregate function can be employed. In this example, a user can simply aggregate using conventional aggregate functions (e.g., count, sum, avg, etc.), and the cloud data platform can internally determine if a table is bound to a noise amount and inject the noise accordingly. For example, when a user runs the following query, the cloud data platform internally injects noise to COUNT (wherein the formula to compute noise is described in detail below) as: SELECT COUNT (email) FROM customers. This example query syntax provides beneficial options as the user does not need to write a separate query for a table with versus without noise. The consumer account will not need to know if a table from the provider in the cleanroom actually specifies a noise. This will allow the provider to not share which table has a noise versus which table does not.

According to a second example, the user's discretion to run a query on a noisy table is provided. In this example, a new set of noisy aggregate functions can be introduced (e.g., noisy_sum, noisy_count, noisy_avg). Users can only use those noisy aggregate functions if a table has an aggregation policy associated with noise specification. The regular aggregate function (e.g., count, sum) will give a user error on those tables. For example, a user will run the following query to COUNT email from table customers: SELECT NOISY_COUNT (email) FROM customers. This example query syntax provides beneficial options as the users would have awareness if they ran a query on a noisy table.

In addition to query syntax, there is also query semantics. For example, query semantics can be used to join multiple tables with noise. If tables in a join have different noise levels, the table with the most restrictive noise will be applied to the aggregate. In the following example, if a customer_p table has noise_level=>′HIGH′ and customer_c=>‘LOW,’ a ‘HIGH’ noise will be added to the COUNT: SELECT COUNT (c.email) FROM customers_p p JOIN customers_c c ON c.email=p.email.

In some example embodiments, users can be provided with alternative options that take the least restrictive option. One example includes interaction with min_group_size. Behavior of min_group_size can be unaltered with the presence of noise. After satisfying the requirements for min group_size, the noise will be added to the aggregates. Another example includes other query semantics/restrictions for aggregation constraints. For example, the generic query semantics for the aggregation constraints will be also applied when the policy also specifies a noise amount. Another example includes more than one aggregate in a query. For example, if there is more than one aggregate in a query, each aggregate can have noise added to it proportional to the aggregate. For example, if there is a query with SUM and COUNT, and the noise level is high, then 10% noise will be added to each aggregate result. By splitting the noise, higher accuracy is retained. In some examples, by splitting the noise, this provides an option to add noise to each aggregate result; for example, if the noise was split by 5% to each aggregate, it would have higher accuracy.

Some example embodiments include common table expressions (CTEs), which are a type of temporary named result set that can be defined within the scope of a single SQL statement, and nested queries. If a query has several aggregates and they are spread out across different levels of nesting, factors are considered as to enforcement of query semantic restrictions and how to add noise. Consider the following example query:

```
::::::CODE::::::
SELECT COUNT(agg.zipcode) FROM (
  SELECT w.zipcode, SUM(w.salary) AS total_salary
  FROM workers w
  GROUP BY w.zipcode
) agg
WHERE agg.total_salary > 1000
::::::CODE::::::
```

Some example embodiments include query semantics restrictions on nested queries where no additional restriction beyond whatever aggregation policy is enforced.

Some example embodiments include noise addition, and varying methods of adding noise. A first example is adding noise only at a topmost level. In the example, only the COUNT is noised up. A second example is adding noise only at the innermost level. In the example, only the SUM is noised up. This option adds the minimum amount of noise and is equivalent to a possible attack where the user first computes the inner queries using noisy aggregation and saving it to temporary tables, then post-processes based on the temporary results without noise. A third example is adding noise up in all aggregations. This is the most privacy-preserving option. A fourth example is adding noise manually. In the manual example, if the cloud data platform decides that the user has to specifically mention which aggregates are to be noised up (e.g., ANON_COUNT), then the cloud data platform avoids having to decide this automatically. For example, a degree of privacy preservation can include the extent or number of protective measures that are applied to safeguard data from being disclosed, accessed, or used in an unauthorized or unintended manner. It can indicate the level of effort and resources dedicated to keeping the data private, which can range from minimal to extremely high, depending on the privacy level set, or the like.

In an example embodiment for determining privacy level, the system includes a privacy level assessment component that includes a trust assessment component, a confidentiality assessment, a risk analysis component, and/or a machine learning engine. The trust assessment component evaluates the trustworthiness of data-sharing partners based on historical interactions and existing contracts. The confidentiality evaluation component assesses the sensitivity of the data based on its content and the potential impact of a data breach. The risk analysis component calculates the probability of re-identification or data inference attacks. The accuracy determination component considers the acceptable level of noise from the perspective of data utility for the end-users. The machine learning engine processes inputs from the aforementioned modules to recommend a privacy level and corresponding noise amount.

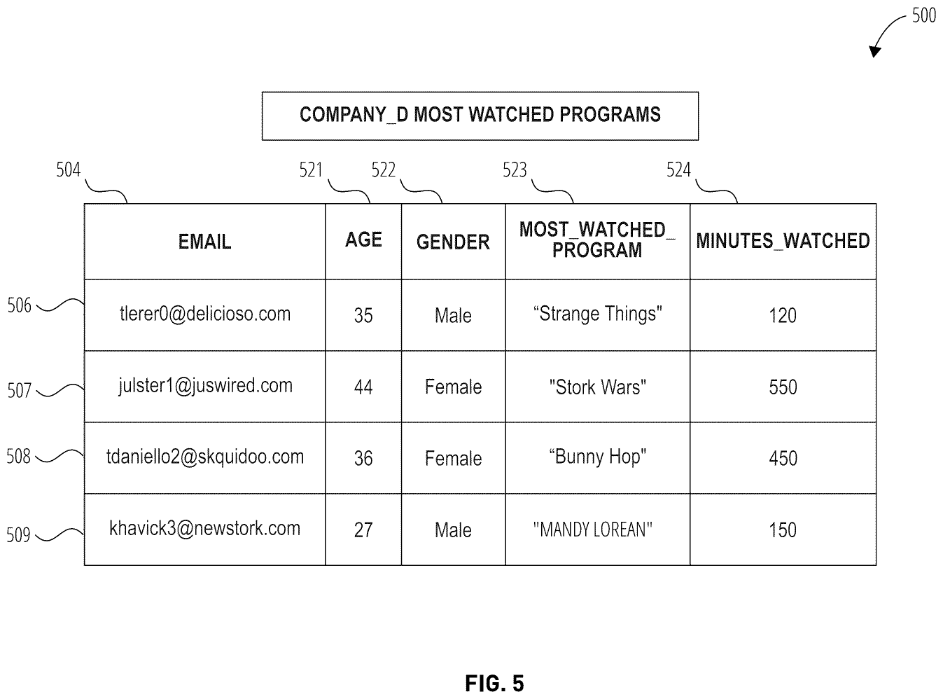

FIG. 5 illustrates a chart 500 of data for displaying Company D's most watched programs, in accordance with some example embodiments.

In an example implementation, a cloud data platform includes one or more databases that are maintained on behalf of a customer account (e.g., accounts of one or more data providers). Data can be shared between a provider account, which owns the data, and a consumer account (e.g., receiver account), which can have access to the data using two-way secure data sharing between private and public clouds according to a relationship establishment procedure (e.g., a handshake) to ensure a trust relationship is established between the provider and the consumer. Indeed, the cloud data platform can include one or more databases that are respectively maintained in association with any number of customer accounts, as well as one or more databases associated with a system account (e.g., an administrative account) of the cloud data platform, one or more other databases used for administrative purposes, one or more other databases that are maintained in association with one or more other organizations or for any other purposes, or some combination thereof. Users or executing processes that are associated with a given customer account can, via one or more types of clients, be able to cause data to be ingested into the database, and can also be able to manipulate the data, add additional data, remove data, run queries against the data, generate views of the data, and so forth.

Moreover, it is often the case that data providers are direct customers of a cloud data platform. As examples, data providers can provide one or more types of data, such as financial data (e.g., stock prices), weather data, pandemic test results, vaccination levels, and/or the like. These data providers typically have one or more customers of their own that consume the data; these entities are referred to in the present disclosure as “data consumers” or simply “consumers.” In some examples, a data consumer might be a trading house that consumes financial data from a data provider. A user of the cloud data platform can be a provider that creates “shares” and makes the “shares” available to other users of the cloud data platform to consume. Data providers can share a database with one or more other cloud data platform users, where the cloud data platform maintains and/or supports grants to provide granular access control to selected objects in the database (e.g., access privileges are granted for one or more specific objects in a database). A provider can create a “share” of a database (e.g., a database share), where the “share” can be an object that encapsulates information required to share a database with other users. For example, a share can consist of privileges that grant access to one or more databases, schema containing the objects to share, privileges that grant access to the specific objects in the one or more databases, and/or consumer accounts with which the one or more databases and its objects are shared. The database shares can be configured or created by the provider and accessed or imported by a data consumer, such as a consumer of the cloud data platform.

The example embodiment of chart 500 describes an end-to-end use case between two entities, Company N and Company D. For example, Company N, who is the consumer, wants to find the programs most watched by their customers and use that to target all customers of Company D who watch the same programs. Company D, who is the provider, applies projection and aggregation policies to their table. Company D has a customer table that contains minutes watched 524, most watched program 523, gender 522, age 521, and email 504. They also have another table that holds the customers viewing history and contains HHID, program, date, and minutes watched. Company N also has a customer table that contains name, address, and email. They also have another table that contains the purchase history and contains email, product name, and date purchased.

In the example embodiment of FIG. 5, Company N would like to know which programs their customers watch most. In order to provide this information, Company D will create a new table (i.e., chart 500) to share with Company N that combines the information so that there is only one row per email, such as customers 506/507/508/509, as required by aggregation policies. Company D then applies a projection policy on the email column and an aggregation policy on the table before sharing to Company N.

According to such an example, defining projection policies and aggregation policies in code would look as follows:

```
::::::CODE::::::
//Define projection policy
create or replace projection policy restrict_consumer_accounts as ( ) returns
projection_constraint −> case
  when current_account( ) = ‘provider.account’
  then projection_constraint(allow => true)
  else projection_constraint(allow => false)
end;
//Apply projection policy
alter table companyD.viewer_history.most_watched modify column email set
projection policy restrict_consumer_accounts;
//Define aggregation policy
create or replace aggregation policy aggregate_consumer_accounts as ( ) returns
aggregation_config −> case
  when current_account( ) = ‘provider.account’
  then aggregation_config(minimum_group_size => 0)
  else aggregation_config(minimum_group_size => 100)
end;
//Apply aggregation policy
alter table companyD.viewer_history.most_watched set aggregation policy
aggregate_consumer_accounts;
::::::CODE::::::
```

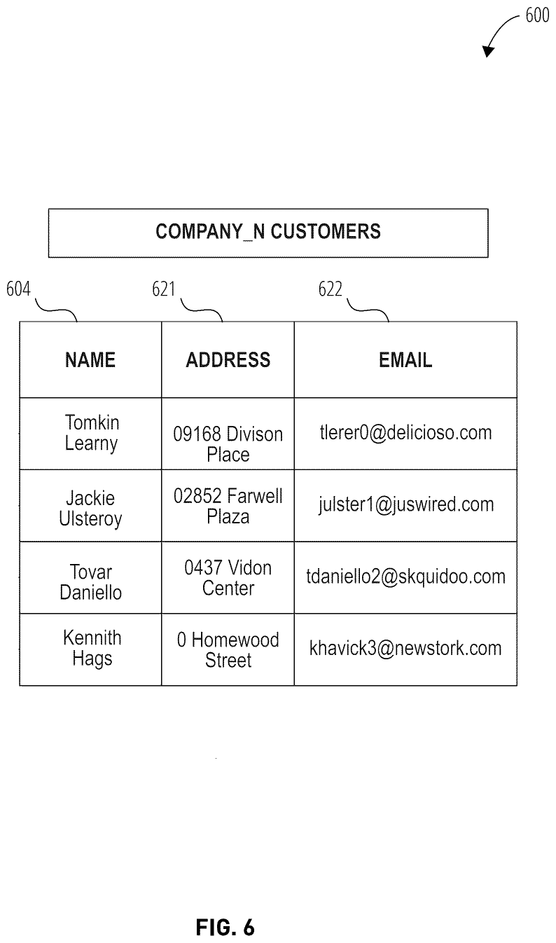

FIG. 6 illustrates a chart 600 depicting data for displaying Company N's customer list, in accordance with some example embodiments.

An embodiment of the present disclosure includes a collaborative data sharing framework that enforces aggregation policies when Company N wishes to query data shared by Company D. The framework ensures that any query results adhere to predefined aggregation constraints, protecting individual customer data from being revealed while allowing Company N to gain insights into their customer base.

Company N has the chart 600 that provides the name 604, address 621, and emails 622 for their customers. Company N, a consumer, wants to determine the average age and gender of their customers based on the most watched programs provided by Company D, a provider.

For example, Company N poses the following query:

```
::::::CODE::::::
select p.most_watched_program, sum(p.minutes_watched) as total_time,
  avg(p.age) as avg_age, p.gender as gender from
  CompanyD.viewer_history.most_watched as p inner join
  CompanyN.customers.contacts as c on p.email = c.email group by
  most_watched_program, gender order by total_time desc;
::::::CODE::::::
```

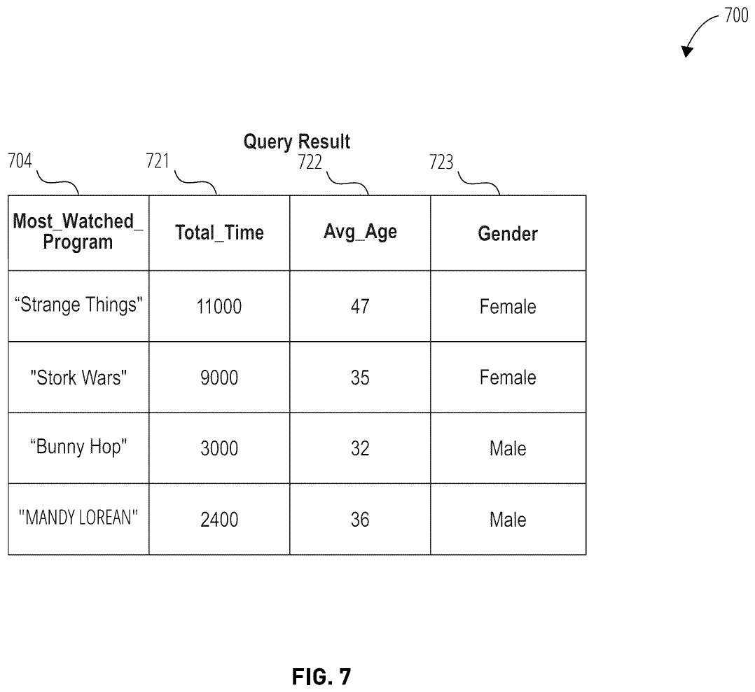

Based on the posed query, Company N receives the query result as illustrated in FIG. 7.

FIG. 7 illustrates a chart 700 depicting data displaying query results associated with FIG. 6, in accordance with some example embodiments.

Based on the query posed in the example of FIG. 6, an example system generates the chart 700 to provide the query results to Company N, the consumer. In some examples, the provider (Company D) is also provided access to the query results. The chart 700 shows the most watched program 704 based on the total time 721 watched by a user, further identified by the user's average age 722 and the user's gender 723.

An embodiment of the present disclosure includes a query result anonymization component that applies noise to query results, such as those displaying the effectiveness of an advertising campaign. The component ensures that individual data points cannot be discerned, thereby maintaining the anonymity of the subjects within the dataset.

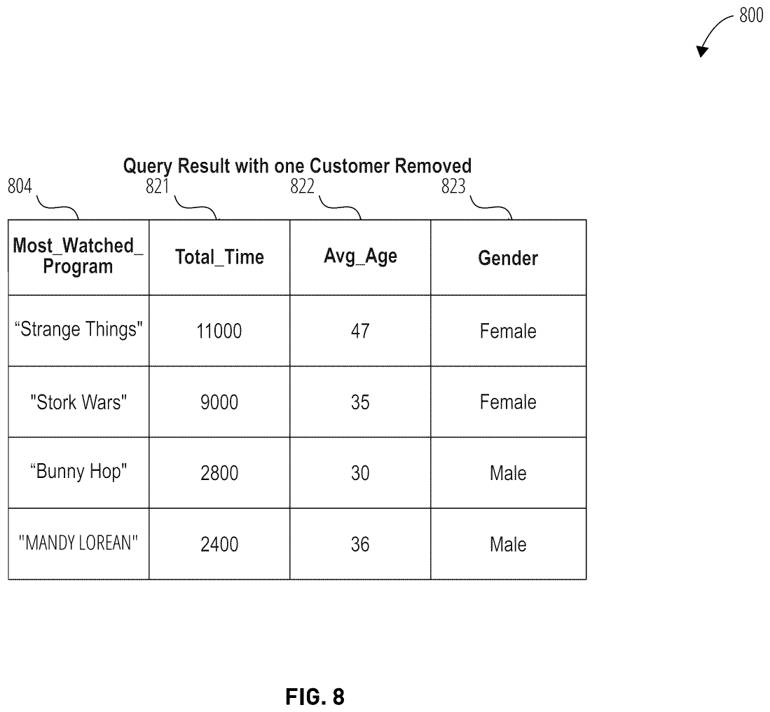

However, suppose Company N removes one customer from their table. Now the result could change and look like the chart 800 as described and depicted in connection with FIG. 8.

FIG. 8 illustrates a chart 800 of data for displaying query results from FIG. 7 with one customer removed, in accordance with some example embodiments.

An embodiment of the present disclosure includes a differential privacy enforcement system that adds noise to query results when a subset of data, such as one customer's information, is removed from the dataset. This system prevents the isolation of individual data points, ensuring compliance with privacy standards even when the dataset composition changes.

The chart 800 provides the query results from FIG. 7 with one customer's information removed. The results provided to Company N still provide the most watched program 804 according to the total time 821 watched based on the customer's average age 822 and gender 823. However, Company N can now ascertain that the customer they removed watched The Bunny Hop for 200 minutes and it was their most watched show. While this example is relatively benign in terms of the sensitivity of the attributes, it does show how easy two queries can reveal information that an individual may not want to be revealed. However, according to example embodiments of the present disclosure, noisy aggregates as disclosed herein prevent this benign disclosure of an attribute because noise would get added to the data.

For example, Company D defines a new aggregation policy with noise as follows:

```
::::::CODE::::::
//Define aggregation policy with noise
create or replace aggregation policy
aggregate_consumer_accounts_noisy
as ( ) returns aggregation_config −>
case
  when current_account( ) = ‘provider.account’
  then aggregation_config(minimum_group_size => 0, noise_amount =>none)
  else aggregation_config(minimum_group_size => 100, noise_amount =>high)
end;
//Apply aggregation policy
alter table CompanyD.viewer_history.most_watched set aggregation policy
  aggregate_consumer_accounts_noisy;
::::::CODE::::::
```

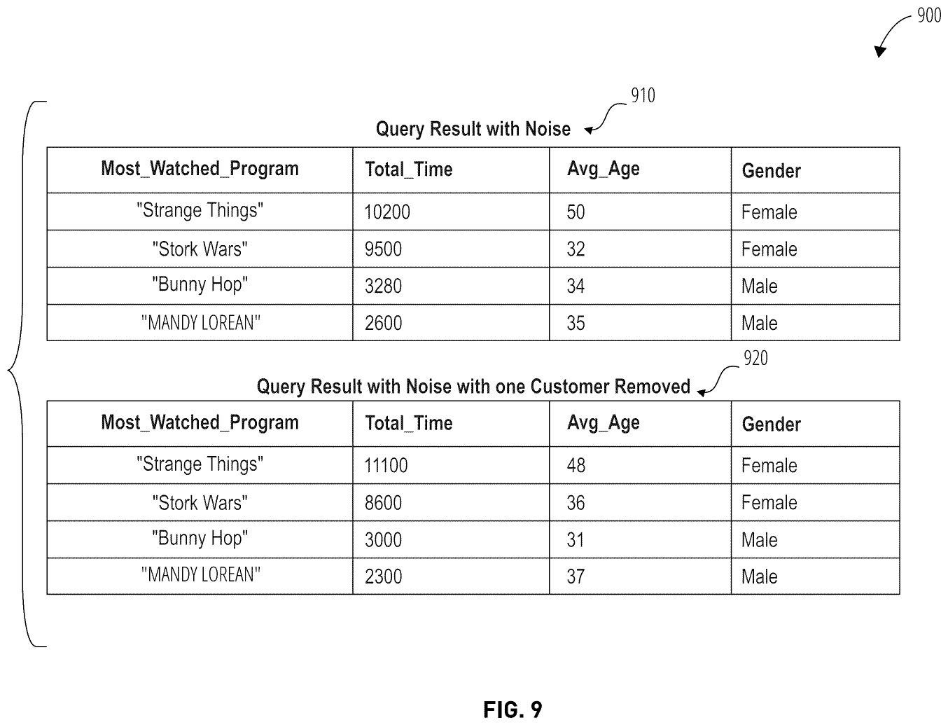

By applying the aggregation policy with noise, the query will return tables 900 described and depicted in connection with FIG. 9.

FIG. 9 illustrates results tables 900 depicting query results with noise, in accordance with some example embodiments.

Specifically, FIG. 9 illustrates a query result with noise chart 910 of data for displaying query results with noise and a query result with noise chart with one customer removed 920 of data for displaying query results with noise with one customer removed, in accordance with some example embodiments.

Company N notices that all the values change in the resulting query result with noise charts 910 and 920, and Company N cannot discern which rows each customer is contributed to, thereby succeeding in using noisy aggregates to block the unwanted dissemination of private data.

An embodiment of the present disclosure includes an adaptive noise injection tool that adds varying levels of noise to query results based on the sensitivity of the data. The tool dynamically adjusts the noise level to mitigate the risk of differencing attacks, ensuring that the privacy of individuals in the dataset is preserved.

Examples provide the functionality of the noise specification component within the query processing system. For example, the noise specification component provides the ability of the system to control the amount of noise injected into query results on a per-entity basis, such as by user, role, account, etc. This can be achieved, for example and not for limiting purposes, by incorporating context functions into the policy expression that governs the application of noise. The noise specification component is a part of the constraint aggregation system that allows data providers (e.g., a database administrator or data stewards) to define how much noise should be added to aggregated query results to protect sensitive data. This component is responsible for interpreting and applying the noise specifications as defined in the aggregation constraint policies.

Further examples provide for entity granularity, which refers to the system's ability to apply different levels of noise based on the entity making the query. An entity can be a user, a role within the system, an account, or any other identifiable actor or group within the system that can make or request a query. Context functions are special functions used within policy expressions to determine the context of a query. These functions can evaluate various aspects of the query's context, such as the identity of the user making the query, the time the query is made, the source of the query, or any other relevant contextual information. For example, a context function might be current_user( ) which returns the user ID of the person making the query, or current_role( ) which returns the role associated with the user making the query. By including context functions in the policy expression, the noise specification component can dynamically adjust the noise level based on the entity making the query. For instance, a policy might specify that queries made by a certain role or during a certain time of day should have a higher level of noise to ensure additional privacy.

For example, a policy can use the current_role( ) context function to determine the role of the entity making the query. Based on the role, it assigns a predefined noise level (e.g., LOW, MEDIUM, HIGH) to the query results. This allows the system to tailor the privacy protection to the sensitivity of the entity's access level or trustworthiness. By integrating context functions into the noise specification, the system can provide a flexible and granular approach to data privacy, ensuring that the noise injected into query results is appropriate for the context of each query, thereby enhancing the overall security and privacy of the data within the query processing system.

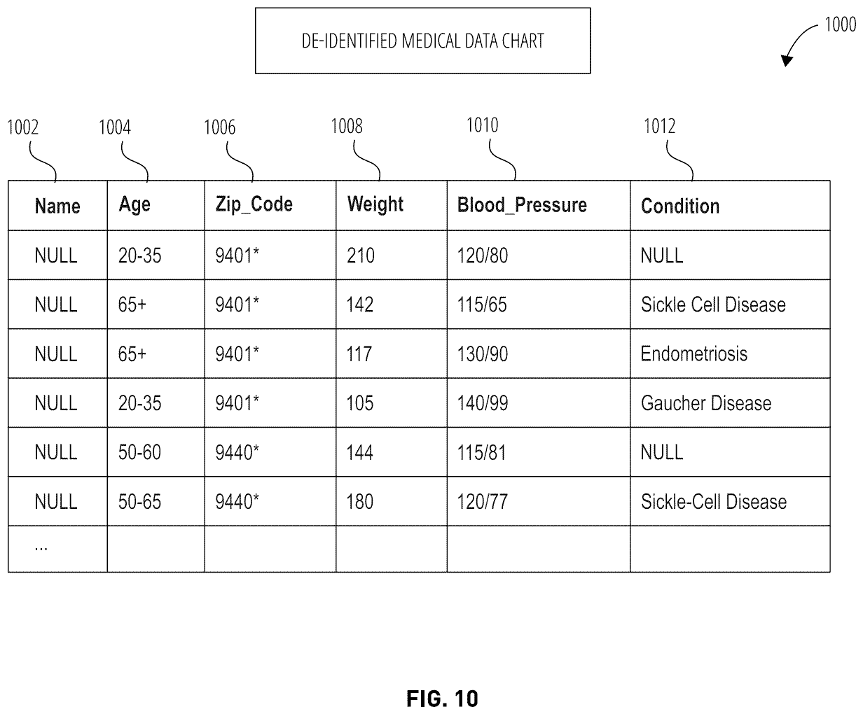

FIG. 10 illustrates a de-identified medical data chart 1000 depicting deidentified medical data, in accordance with some example embodiments.

An embodiment of the present disclosure involves a framework for analyzing the impact of noise on the accuracy of query results. The framework provides tools for users to assess the trade-off between data privacy and utility when applying noisy aggregates to query results, such as deidentified medical data. Some examples include an enhanced data anonymization service that applies advanced anonymization techniques, such as differential privacy, to medical datasets. The service ensures that sensitive health information remains confidential while still allowing for meaningful analysis of the data. An example of a noisy aggregate query result analysis framework can include a query result analysis component, a noise impact visualization component, and/or a provenance tracking component. The query result analysis component calculates the deviation of noisy query results from the true values. The noise impact visualization component graphically represents the distribution of noise and its impact on query accuracy. The provenance tracking component records the history of noise injection for auditability and compliance purposes.

The de-identified medical data chart 1000 is used to delineate a comparison between aggregation constraints and k-Anonymity. The de-identified medical data chart 1000 illustrates the scenario where customers may combine aggregation constraints with our anonymization feature, which transforms a data set to guarantee k-anonymity.

In this scenario, the customer has produced a 2-anonymous dataset, where name 1002 is deemed to be an identifier; zip code 1006 and age 1004 are deemed to be quasi-identifiers; and weight 1008 and blood pressure 1010 are deemed to be sensitive attributes. Unfortunately, k-anonymity is not fully satisfying here. For example: If an analyzer can make an educated guess about an individual's weight, the analyzer could determine their medical conditions 1012.

In addition, all of the diseases in the de-identified medical data chart 1000 are too rare to treat as quasi-identifiers without losing analytical value. However, they can also be used to determine other attributes for individuals. In particular, all the diseases in the de-identified medical data chart 1000 have strong gender or ethnic correlations, which makes them quasi-identifying in combination with external demographic data. For example, if an individual of Ashkenazi descent living in ZIP code 94010 is represented in the dataset, an analyzer can conclude with reasonable certainty that she weighs 105 pounds and has Gaucher's disease.

These attacks against the k-anonymized dataset are possible because it is easy to directly observe correlations between attributes for a single individual. Aggregation constraints prevent this. For example, if an aggregation constraint is applied to the view above, it is no longer straightforward to associate weight=105 with condition=Gaucher Disease.

However, a determined adversary could still infer some of these associations. For example, aggregation constraints would still permit the data consumer to query the average weight of individuals with Gaucher's disease across a broad swath of ZIP codes. The adversary could query this average across two sets of ZIP codes: one that contains 94010 and one that does not. The difference in the averages and total count could be used to infer the weight of the individual in 94010. However, this requires a series of queries that would potentially also be subject to audit.

According to example embodiments presented herein, the addition of noisy aggregates to the deidentified medical data of de-identified medical data chart 1000 would help to obfuscate the private data. Additional aggregation constraints can further specify a privacy budget or amount of noise to add in order to further conceal PII.

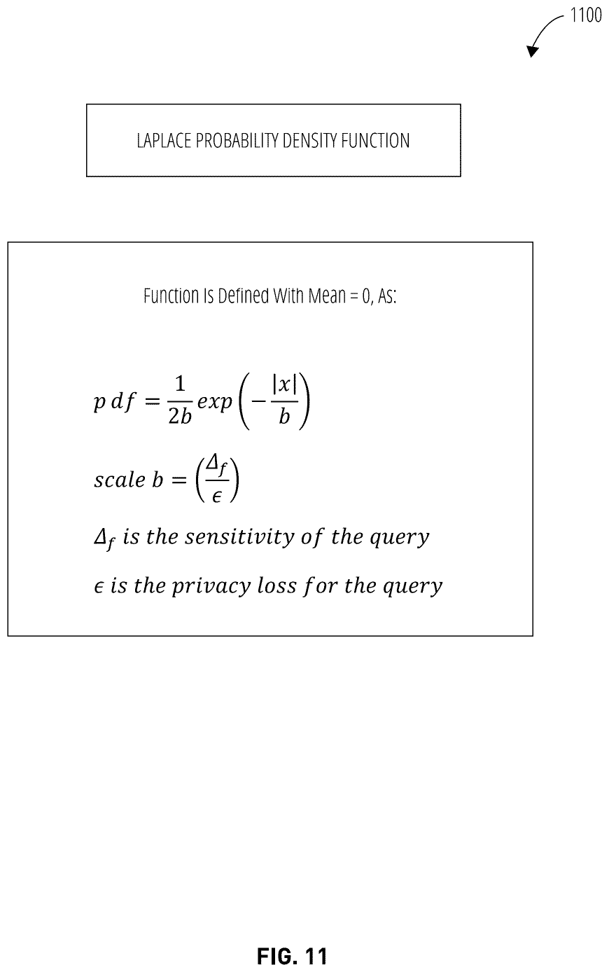

FIG. 11 illustrates an example formula 1100 for noisy aggregates, in accordance with some example embodiments.

An embodiment of the present disclosure includes a probabilistic noise modeling framework that utilizes the Laplace probability density function to determine the appropriate noise to add to aggregated query results. The framework allows for the customization of noise parameters to fit the privacy requirements of different datasets and query types. However, for example embodiments of noisy aggregates, it is preferred for the customer to specify the privacy level or profile yet to be determined. This can then correspond internally to varying options, including, for example: (1) An amount of noise added to queries, for example 10% or (2) A value for epsilon, the sensitivity will be based on the aggregate. For example, the Laplace probability density function can be sampled to obtain noise. Example embodiments of the present disclosure determine the values for epsilon and sensitivity based on the aggregate function (SUM, COUNT, AVERAGE).

In some example embodiments of noisy aggregates related to query constraints, constructs that would allow for amplification are limited and/or disallowed. Amplification means that a single row has an outsized impact on the output. For example, the SQL function amplifies outliers, and exploding joins will amplify/duplicate rows. The use of noisy aggregates makes it possible to bound the information loss of these queries (e.g., within the meaning of differential privacy) by injecting noise proportional to the value range in the aggregated columns. Thereby enabling the use of noisy aggregates to defend against differencing attacks by injecting noise into the aggregate result.

Some example embodiments include the use of transformation. Unlike in the WHERE and ON clauses of the query, the transformations need to be restricted that are allowed in the SELECT list. In one implementation, TRY_CAST to numeric types are enabled, specifically: TRY_CAS (x AS <type>), TRY_TO_NUMBER, TRY_TO_DECIMAL, TRY_TO_NUMERIC, and TRY_TO_DOUBLE. TRY_CAST( ) and not regular CAST is allowed because that CAST creates an error channel: it leaks the value that it failed to cast. In such examples, restricting transformations is performed because the transformations can amplify the values of specific individuals, which may violate those individuals' privacy. In other words, it would be a violation of the aggregation constraint policy. For example, the expression LOG(AVG(EXP(salary))) in a GROUP BY query returns approximately the highest salary in each group. According to some example embodiments, noisy aggregates would solve this problem when noise was injected proportional to the range of input values to the AVG ( ) aggregate.

Some example embodiments address how to sample the Laplace distribution such that the aggregate has the specified amount of noise. For example, in order to get the right amount of noise from sampling the Laplace distribution a few assumptions are made, including: (1) Confidence level for the amount of noise in order to integrate the pdf, and (2) Model the noise addition as noisyagg=truevalue(1+N), where truevalue is the true value for the aggregate such as count or sum, and N is the noise, for example 0.01=1%

In such example embodiments, a 99% confidence interval is recommended since the Laplace distribution can have quite long tails and may give consumers surprisingly large values of noise. This will constrain the noise values to be within the specified value with 99% confidence. Finding the value of b for the Laplace distribution that will satisfy the specified noise by integrating the Laplace up to the maximum expected noise amount. Since the mean is 0 and the Laplace is symmetric about the mean, the confidence interval can be calculated by integrating only one side (x>0) of the distribution and doubling it to obtain the 99% confidence interval. For example:

$$2 \times {\int }_{0}^{maxerror} \frac{1}{2 b} exp ( - \frac{x}{b} ) d x = 0.99$$

### Example Algorithm for Calculating Confidence Interval

Where simplifying and solving for b, the answer is: b=maxerror/log (100), where maxerror=% noise×truevalue.

Some example embodiments address how noisy count will be calculated as the true count plus some addition of noise generated from the Laplace mechanism. For example, for noisy count, the following are specified: N=0.05 or 5% noise, truevalue=1000, maxerror=0.05×1000=50, b=50/log (100)˜10.86=Δƒ/ϵ. To compare to sensitivity and epsilon used in DP Δƒ=1 for count=⇒ϵ˜0.092 (although in some examples sensitivity or epsilon do not need to be calculated for noisy aggregates). The results from sampling the Laplace return values between +50˜99% of the time.

Some example embodiments address how noisy sum will be calculated in a similar way, for example, as the true sum plus some noise from the Laplace mechanism. For example, for noisy sum, the following are specified: N=0.1 or 10% noise, truevalue=10000, maxerror=0.1×10000=1000, b=1000/log (100)˜217.15=Δ_{ƒ}/ϵ. To compare to sensitivity and epsilon used in DP, Δ_{ƒ}=max (|L|, |U|) for sum, where L is the minimum value in the column to be summed and U is the maximum value⇒ϵ=max (|L|, |U|)/217.15, if max (|L|, |U|)=20 then ϵ˜0.092. The results from sampling the Laplace return values between ±1000˜99% of the time.

Some example embodiments address how noisy average is calculated in a different way, which is as a normalized noisy sum divided by a noisy count. It allows the average to be calculated with half the sensitivity it would otherwise, thereby generating better accuracy. For example, for noisy sum, the following are specified: N=0.03 or 3% noise, truecount=1000, truesum=10000, truemean=10, U=20, L=2, maxerrorsum=0.03×(10000)=300, maxerrorcount=0.03×1000=30, bsum=300/log (100)˜65.

$$noisyavg = \frac{( t r u e s u m - t r u e c o u n t \times ( U - L ) / 2 + L a p l c e ( {b}_{s u m} )}{max ( 1 , t r u e c o u n t + L a p l a c e ( {b}_{count} ) )} + ( U - L ) / 2$$

### Example Algorithm for Noisy Average

The results from the above will return values ±0.3˜99% of the time.

Further example embodiments of the present disclosure include using noisy aggregates to combat, overcome, protect against, or hinder attacks. There are three main attacks on aggregate queries: (1) differencing, (2) averaging, and (3) database reconstruction. A differencing attack is one in which a consumer runs two queries and by taking the difference of the aggregate results can learn information about an individual:

```
::::::CODE::::::
SELECT COUNT(*) FROM loans WHERE loanStatus = ‘C’
  AND clientId BETWEEN 2000 and 3000
SELECT COUNT(*) FROM loans WHERE loanStatus = ‘C’
  AND clientId BETWEEN 2000 and 3000
  AND clientId != 2044
::::::CODE::::::
```

In this case, the user would learn the value of client 2044's loan value. The defense is to add noise by sampling a distribution like Gaussian or the Laplacian. However, if the distribution has zero mean the user can average the results of a query asked multiple times to remove the noise and even if it does not have zero mean it is possible to obtain the bias along with the true answer. This is called an averaging attack. One defense for this is to have the same noise returned for the same query result. This is possible in the cloud data platform for syntactically similar queries by using the result cache. However, the result cache is per-session, and it can be disabled, therefore it will not provide much of a defense against a motivated attacker. Additionally, if the user constructs several queries that are slightly different but are aimed at producing the same result the user can still successfully leverage the averaging attack. Another defense is to limit the number of queries, which once it is consumed the user can no longer ask queries. Some example embodiments include setting a maximum number of queries as part of the privacy level.

The last attack is a database reconstruction attack. The attacker submits sufficiently random queries that link information the attacker already knows to information that the attacker wants to learn. The attacker receives noisy answers to these queries and uses them as constraints in a linear program to solve for the information that the attacker wants to learn. The attacker solves the linear program to recover the private information. The defense to this attack is to limit the number of queries on the dataset and make sure that the queries are answered with sufficient noise. Database reconstruction attacks are fairly sophisticated, but example embodiments employ scaling the noise appropriately and limiting the number of queries allowed.

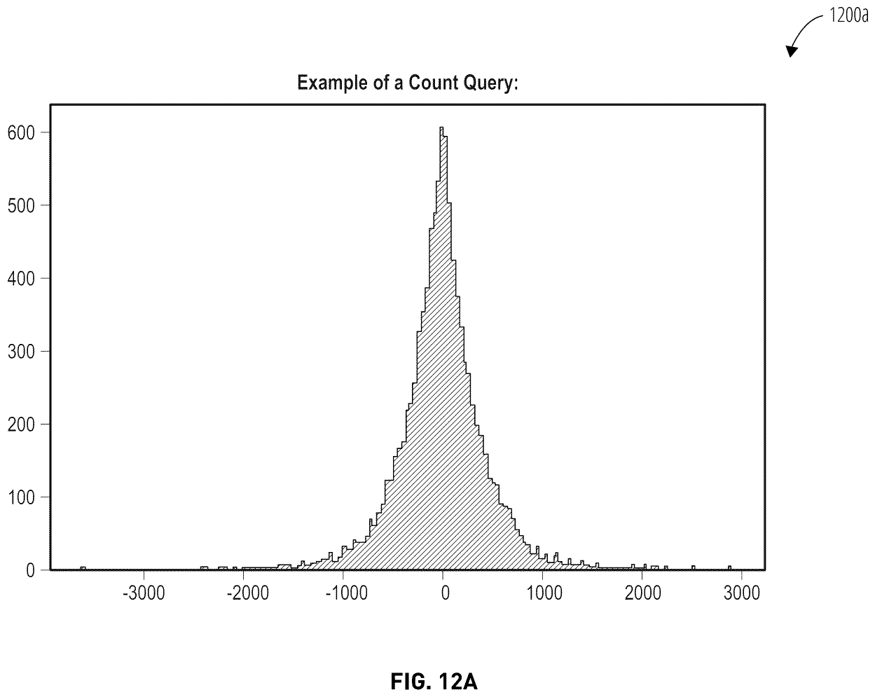

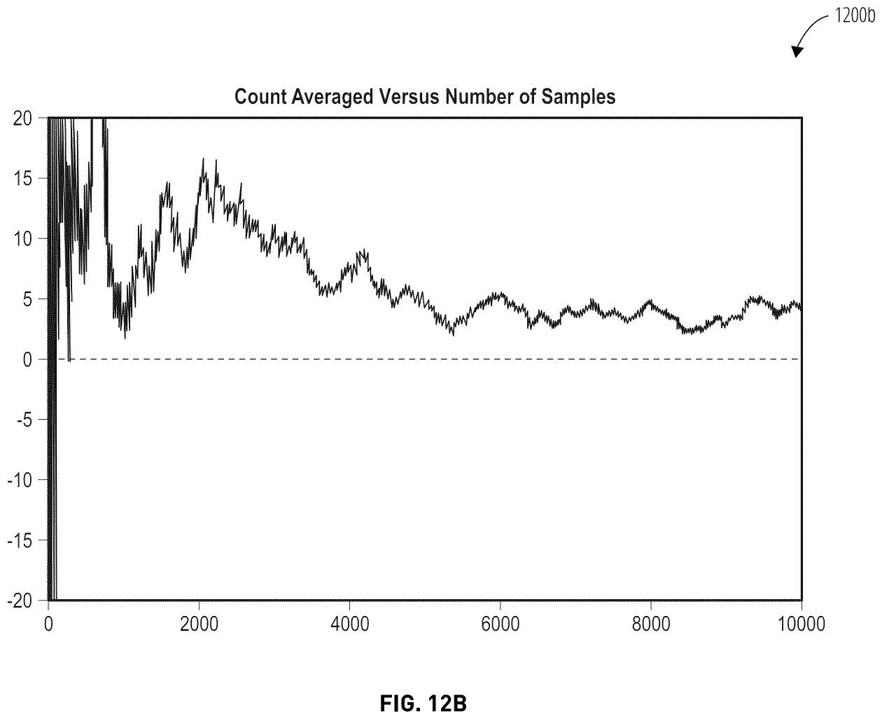

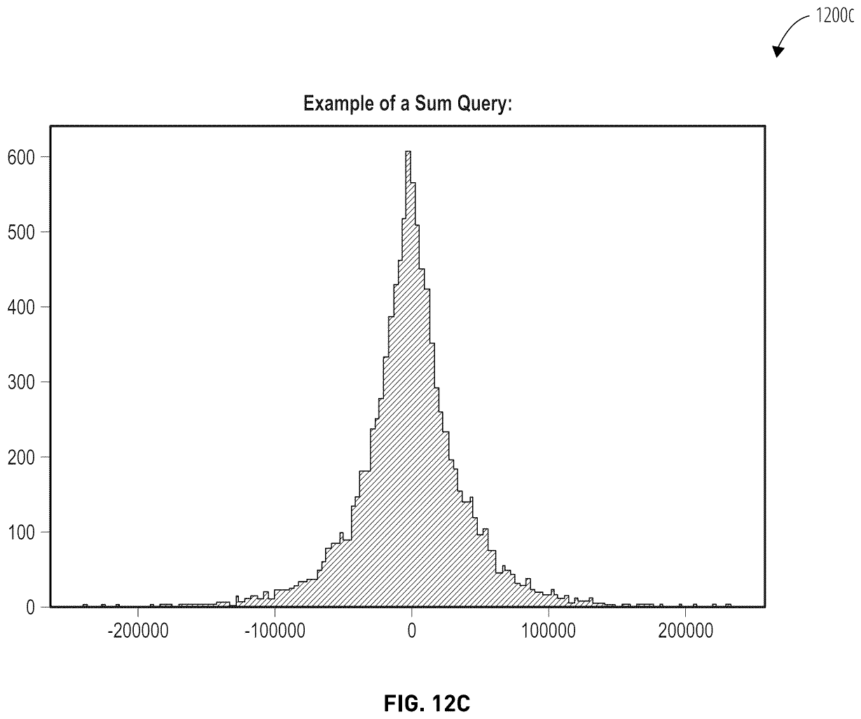

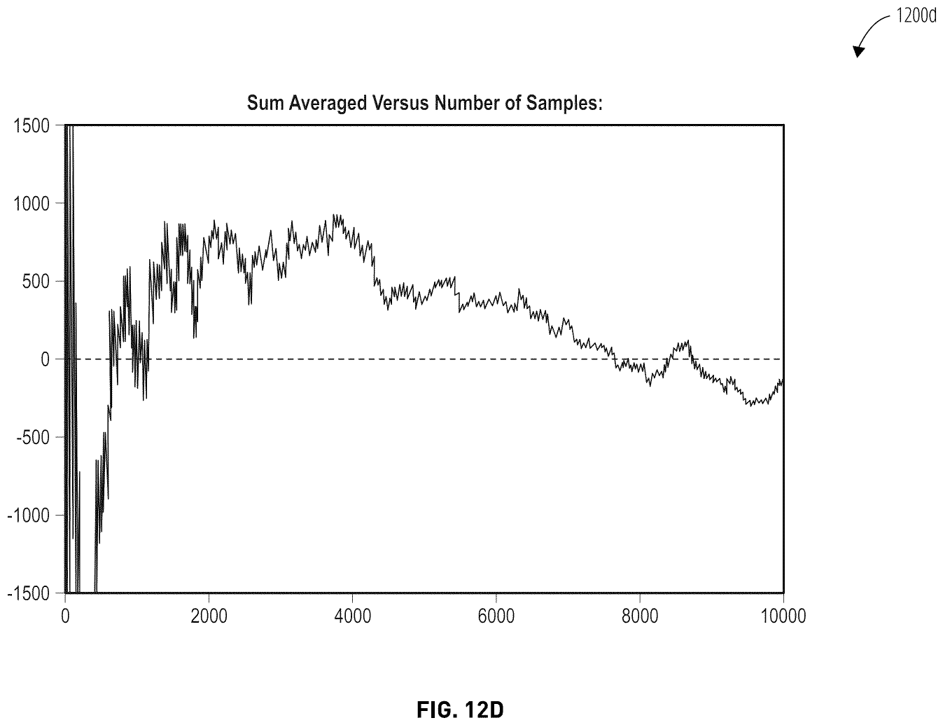

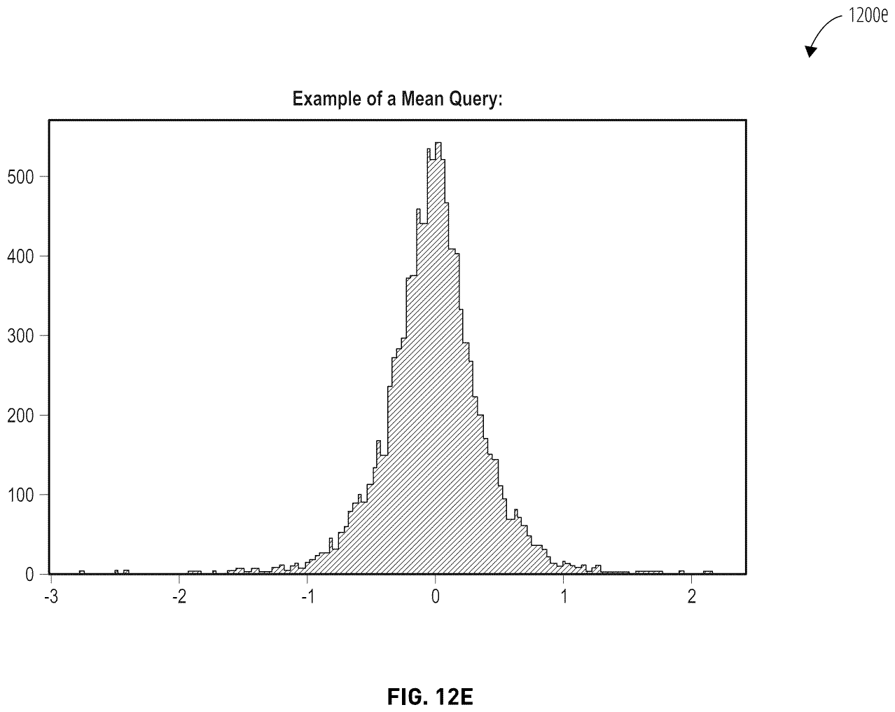

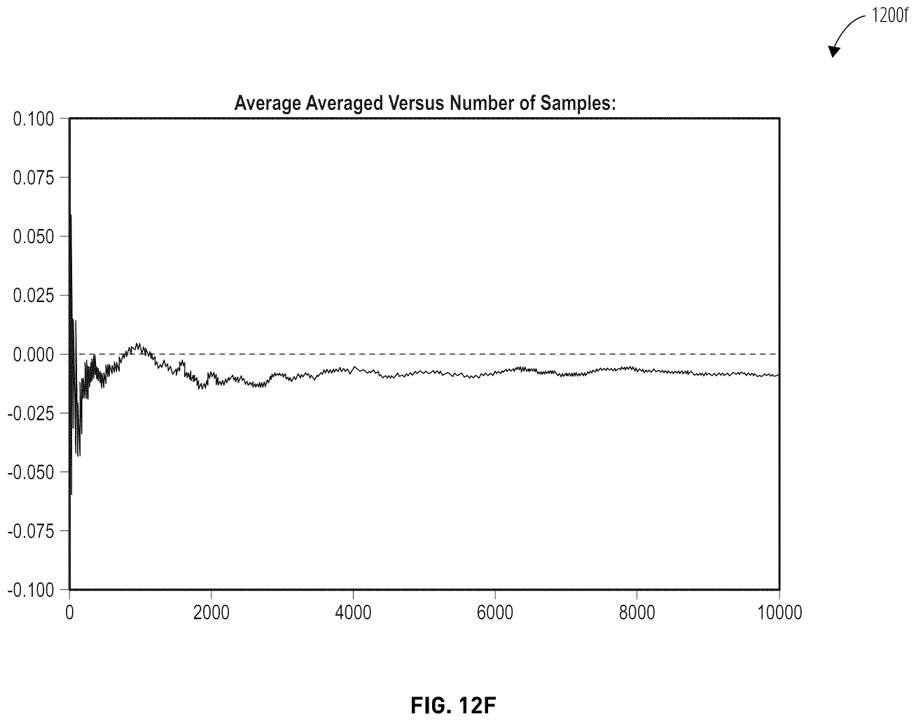

FIG. 12A to FIG. 12F illustrate various examples of Python code and corresponding output values displayed in graphical format, in accordance with some example embodiments.

Specifically, the example embodiments illustrated in FIGS. 12A to 12F include examples in Python code of a noisy count, noisy sum, and noisy average, using the geometric mechanism to draw noise from the double-geometric distribution, which is the discrete version of the Laplace distribution. Since the distribution is supported by the integers rather than the real numbers, the output value is guaranteed to be an integer as is the case in the count and sum examples below.

FIG. 12A illustrates a graph 1200a depicting an example of a count query, in accordance with some example embodiments.

For example, the graph 1200a is generated based on the following code:

::::::CODE::::::
import numpy as np
import math
import matplotlib.pyplot as plt
target = adult[‘Age’].sum( ) print(“True answer”, target)
noise = int(input(“Enter noise level as a percentage: ”)) max_error = int(target * noise /
100)
print(“noise level =”, noise, “%”, “maximum error =”, max_error, “equivalent epsilon”,
math.log(100) / max_error * max(abs(adult[‘Age’].max( )), abs(adult[‘Age’].min( ))))
p = 1 − np.exp(−math.log(100) / max_error) Z = np.random.geometric(p) −
np.random.geometric(p) print(‘A sample noisy sum’, target + Z)
noise_list = [np.random.geometric(p) − np.random.geometric(p) for x in range(10000)] n,
bins, patches = plt.hist(x=noise_list, bins=‘auto’)
out_of_bounds = len([i for i in noise_list if i >= max_error or i <= −max_error])
print(‘Number of values >’, max_error, ‘and <’, −max_error, ‘=’, out_of_bounds)
print(‘Percent of values within +/−’, noise, ‘% of true answer’, 100 − out_of_bounds /
len(noise_list) * 100, ‘%’) print(‘Max noise value’, max(noise_list), ‘Min noise value’,
min(noise_list))
::::::CODE::::::

Based on the graph 1200a generated by the above example code, the following output can also be provided. For example, the true answer (14237), the noise level as a percentage (10%), a maximum error (1423), an equivalent epsilon (0.00323624046), a sample noisy count (14424), a number of values between identified numbers (107), percentage of values within +/−10 percent of a true answer (98.93%), a max noise value (2908), and a min noise value (−3622).

An embodiment of the present disclosure includes a customizable noise function library for use in query processing systems. The library provides a collection of noise functions and templates that can be applied to various types of data queries, including count, sum, and average, as demonstrated through Python code examples. For example, a library can include a set of predefined noise functions based on different probability distributions, including the Laplace distribution. The library can further include a customization interface that allows users to define and save their own noise functions tailored to specific data types or privacy requirements. The library can further include an integration module that facilitates the incorporation of the noise functions into existing query processing workflows within cloud data platforms. These embodiments enhance the capabilities of cloud data platforms to manage the privacy of shared data through the use of noisy aggregates, providing a balance between data utility and the protection of sensitive information.

FIG. 12B illustrates a graph 1200b depicting an example of count averaged versus number of samples, in accordance with some example embodiments.

For example, the graph 1200b is generated based on the following code:

::::::CODE::::::
x0=[0,10000]
y0=[0,0]
y3=pd.DataFrame (noise_list).expanding(1).mean( )
plt.plot (x0,y0, ‘r’, y3, ‘b’)
1=plt.axis( [0,10000,−20,20] )
::::::CODE::::::

FIG. 12C illustrates a graph 1200c depicting an example of a sum query, in accordance with some example embodiments.

For example, the graph 1200c is generated based on the following code:

::::::CODE::::::
import numpy as np
import math
import matplotlib.pyplot as plt
target = adult[‘Age’].sum( ) print(“True answer”, target)
noise = int(input(“Enter noise level as a percentage: ”)) max_error = int(target * noise /
100)
print(“noise level =”, noise, “%”, “maximum error =”, max_error, “equivalent epsilon”,
math.log(100)/max_error * max(abs(adult[‘Age’].max( )), abs(adult[‘Age’].min( ))))
p = 1 − np.exp(−math.log(100)/max_error) Z = np.random.geometric(p) −
np.random.geometric(p) print(‘A sample noisy sum’, target + Z)
noise_list = [np.random.geometric(p) − np.random.geometric(p) for x in range(10000)] n,
bins, patches = plt.hist(x=noise_list, bins=‘auto’)
out_of_bounds = len([i for i in noise_list if i >= max_error or i <= −max_error])
print(‘Number of values >’, max_error, ‘ and <’, −max_error, ‘ = ’, out_of_bounds)
print(‘Percent of values within +/−’, noise, ‘% of true answer’, 100 −
out_of_bounds/len(noise_list) * 100, ‘%’) print(‘Max noise value’, max(noise_list), ‘Min
noise value’, min(noise_list))
::::::CODE::::::

Based on the graph 1200c generated by the above example code, the following output can also be provided. For example, the true answer (1256257), the noise level as a percentage (10%), a maximum error (125625), an equivalent epsilon (0.0032992264019), a sample noisy sum (1286980), a number of values between identified numbers (105), percentage of values within +/−10 percent of a true answer (98.95%), a max noise value (234303), and a min noise value (−240726).

FIG. 12D illustrates a graph 1200d depicting an example of sum averaged versus number of samples, in accordance with some example embodiments.

For example, the graph 1200d is generated based on the following code:

::::::CODE::::::
x0=[0,10000]
y0=[0,0]
y3=pd.DataFrame (noise_list).expanding(1).mean( )
plt.plot (x0,y0, ‘r’ , y3, ‘b’)
1=plt.axis( [0,10000,−1500,1500] )
::::::CODE::::::

FIG. 12E illustrates a graph 1200e depicting an example of a mean query, in accordance with some example embodiments.

For example, the graph 1200e is generated based on the following code:

::::::CODE::::::
import numpy as np
import math
import matplotlib.pyplot as plt
tarsum = adult[‘Age’].sum( ) tarcount = np.array(len(adult[‘Age’])) target = tarsum / tarcount
print(“True mean”, target)
lower = adult[‘Age’].min( ) upper = adult[‘Age’].max( ) midpoint = lower + (abs(upper) −
abs(lower)) / 2
noise = int(input(“Enter noise level as a percentage: ”)) sum_error = tarsum * noise / 100
count_error = tarcount * noise / 100 max_error = target * noise / 100
print(“noise level =”, noise, “%”, “maximum error =”, max_error) print(“equivalent epsilon
for sum”, midpoint * math.log(100) / sum_error, “equivalent epsilon for count”,
math.log(100) / count_error)
p3 = 1 − np.exp(−math.log(100) / sum_error) noise_list3 = [np.random.geometric(p3) −
np.random.geometric(p3) for x in range(10000)] stilda = tarsum − tarcount * midpoint +
noise_list3
p3b = 1 − np.exp(−math.log(100) / count_error) noise_list3b = [np.random.geometric(p3b)
− np.random.geometric(p3b) for x in range(10000)] ctilda = tarcount + noise_list3b
noisy_avg = np.divide(stilda, ctilda) + midpoint
out_of_bounds = len([i for i in noisy_avg if i >= target + max_error or i <= target −
max_error]) print(“Number of values out of bounds”, out_of_bounds, “Percent within noise
level”, 100 − out_of_bounds / len(noisy_avg) * 100)
n = plt.hist(x=noisy_avg − target, bins=‘auto’)
::::::CODE::::::

Based on the graph 1200e generated by the above example code, the following output can also be provided. For example, the true mean (38.58164675532078), the noise level as a percentage (3%), a maximum error (1.1574494026596236), an equivalent epsilon for sum (0.006537319591727991), an equivalent epsilon for count (0.004714402901209107), a sample noisy count (14424), a number of values out of bound (118), and percentage of values within noise level (98.82%).

FIG. 12F illustrates a graph 1200f depicting an example of an average averaged versus number of samples, in accordance with some example embodiments.

For example, the graph 1200f is generated based on the following code:

::::::CODE::::::
x0=[0,10000]
y0=[0,0]
y3=pd.DataFrame (noisy_avg-target).expanding(1).mean( )
plt.plot (x0,y0, ‘r’ , y3, ‘b’)
1=plt.axis( [0,10000,−0.1,0.1] )
::::::CODE::::::

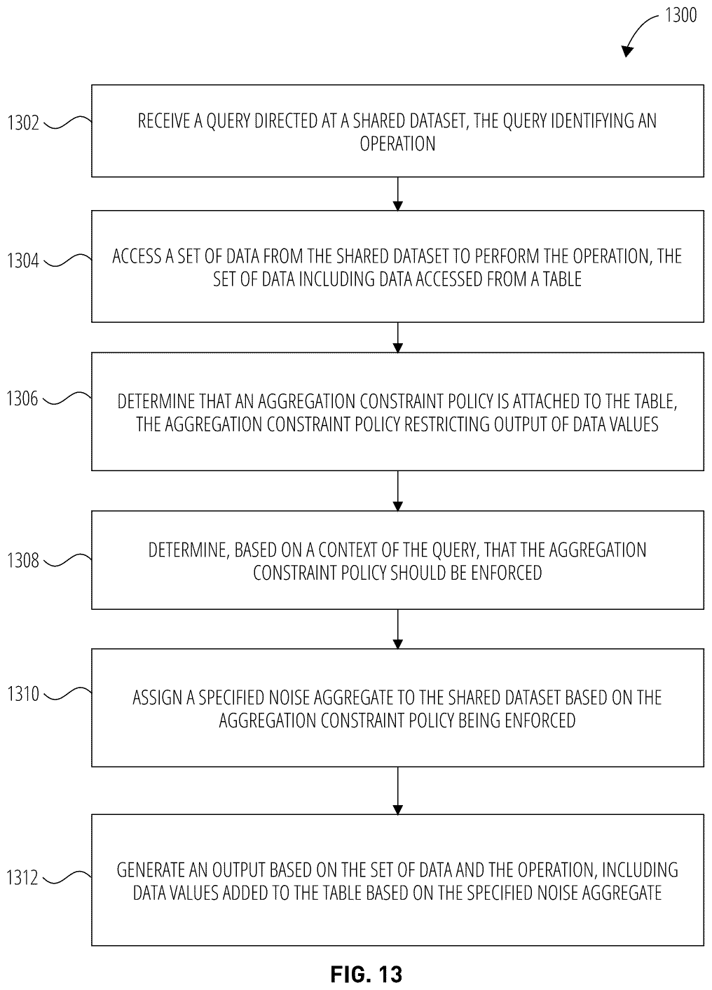

FIG. 13 illustrates a flow diagram of a method 1300 for assigning a specified noise level or aggregate to a shared dataset, in accordance with some example embodiments. The method 1300 can be embodied in machine-readable instructions for execution by one or more hardware components (e.g., one or more processors, one or more hardware processors, at least one hardware processor, etc.) such that the operations of the method 1300 can be performed by components of the systems depicted in FIG. 1, FIG. 2, and/or FIG. 14, such as the user device 104, the compute service manager 108, the execution platform 110, or component thereof. Accordingly, the method 1300 is described below, by way of example with reference to components of the compute service manager 108. However, it shall be appreciated that method 1300 can be deployed on various other hardware configurations and is not intended to be limited to deployment within the hardware of examples presented herein.

Depending on the example embodiment, an operation of the method 1300 can be repeated in different ways or involve intervening operations not shown. Though the operations of the method 1300 can be depicted and described in a certain order, the order in which the operations are performed may vary among embodiments, including performing certain operations in parallel or performing sets of operations in separate processes. While the various operations in this flowchart are presented and described sequentially, one of ordinary skill will appreciate that some or all of the operations may be executed in a different order, be combined, or omitted, or be executed in parallel.

At operation 1302, the compute service manager 108 receives a first query directed at a shared dataset, the first query identifying a first operation. At operation 1304, the compute service manager 108 accesses a first set of data from the shared dataset to perform the first operation, the first set of data including data accessed from a first table of the shared dataset. At operation 1306, the compute service manager 108 determines, by at least one hardware processor, that an aggregation constraint policy is attached to the first table, the aggregation constraint policy restricting output of data values stored in the first table.

At operation 1308, the compute service manager 108 determines, based on a context of the first query, that the aggregation constraint policy should be enforced in relation to the first query. At operation 1310, the compute service manager 108 assigns a specified noise level (e.g., amount) or specified noise aggregate to the shared dataset based on the determining that the aggregation constraint policy should be enforced. At operation 1312, the compute service manager 108 generates an output to the first query based on the first set of data and the first operation, the output to the first query including data values added to the first table based on the specified noise level or aggregate.

FIG. 14 is a block diagram 1400 illustrating components of the aggregation system 250 as described and depicted in connection with FIG. 2, according to some example embodiments.

As explained earlier, databases are used by various entities (e.g., businesses, people, organizations, etc.) to store data. For example, a retailer may store data describing purchases (e.g., product, date, price) and the purchasers (e.g., name, address, email address). Similarly, an advertiser may store data describing performance of their advertising campaigns, such as the advertisements served to users, date that advertisement was served, information about the user, (e.g., name, address, email address), and the like. In some cases, entities may wish to share their data with each other. For example, a retailer and advertiser may wish to share their data to determine the effectiveness of an advertisement campaign, such as by determining whether users that were served advertisements for a product ultimately purchased the product. In these types of situations, the entities may wish to maintain the confidentiality of some or all of the data they have collected and stored in their respective databases. For example, a retailer and/or advertiser may wish to maintain the confidentiality of personal identifying information (PII), such as usernames, addresses, email addresses, credit card numbers, and the like. As another example, entities sharing data may wish to maintain the confidentiality of individuals in their proprietary datasets.

An entity sharing data may define the aggregation constraints to be attached to various tables of a shared dataset. For example, the entity may define the table or tables (e.g., or other schema level) that the aggregation constraint should be attached to, as well as the conditions for triggering the aggregation constraint. When a query directed towards the shared dataset is received by the cloud data platform, the aggregation system accesses the data needed to process the query from the shared database and determines whether an aggregation constraint is attached to any of the tables of the shared dataset from which the data was accessed. If an aggregation constraint is attached to one of the tables, the aggregation system determines whether the aggregation constraint should be enforced based on the context of the query and generates an output accordingly. For example, if the aggregation constraint should be enforced, the aggregation system may generate an output that does not include the data values stored in the tables but may provide an output determined based on the constrained data, such as a number of matches, number of fuzzy matches, number of matches including a specified string, unconstrained data associated with the constrained data, and the like.

In some example embodiments, different users can specify different components of an aggregation constraint. For example, users can select one or more of the data to be protected by the constraint, the conditions under which the constraint is enforced (e.g., my account can query the raw data, but my data sharing partner's account can only query it in aggregated form), a minimum group size that queries must adhere to (e.g., each group must contain at least this many rows from the source table), and/or the class of aggregate functions that can be used for each attribute.

In some example embodiments, the aggregation constraint system 250 includes receiving a constraint to a database table from the data steward (e.g., provider). The constraint specifies which principals (e.g., consumers, analysts, roles, etc.) are subject to the constraint. The constraint also specifies, for each principal who is subject to the constraint, the minimum number of rows that must be aggregated in any valid query. If a query does not meet this minimum, data is suppressed, or the query is rejected. Aggregation constraints work with data sharing and collaboration, provided that the sharing occurs on a common, trusted platform. In some example embodiments, the constraint is enforced by a common trusted data platform, (e.g., the cloud data platform). In some example embodiments, the constraint could be enforced without the need to trust a common platform by using either (a) homomorphic encryption or (b) confidential computing.

In some example embodiments, the aggregation system 250 allows multiple sensitive data sets, potentially owned by different stakeholders, to be combined (e.g., joined or deduplicated using identifying attributes such as email address or SSN). The system enables analysts, consumers, and the like to formulate their own queries against these datasets, without coordinating or obtaining permission from the data owner/steward/provider. The system can provide a degree of privacy protection, since analysts are restricted to query only aggregate results, not individual rows in the dataset. The data steward/owner/provider can specify that certain roles or consumers have unrestricted access to the data, while other roles/consumers can only run aggregate queries. Furthermore, the provider can specify that for roles/consumers in the latter category, different consumers may be required to aggregate to a different minimum group size. For example, a highly trusted consumer may be seeing only aggregate groups of 50+ rows. A less trusted consumer may be required to aggregate to 500+ rows. Such example embodiments can express aggregation constraints as a policy, which can be a SQL expression that is evaluated in the context of a particular query and returns a specification for the aggregation constraint applicable to that query.

In some example embodiments, the aggregation system 250 performs operations on the underlying table within the database built into the cloud data platform. The cloud data platform, or a trusted database processing system, can perform the aggregation policies according to different example embodiments as described throughout.

Enforcing aggregation constraints on queries received at the cloud data platform 102 allows for data to be shared and used by entities to perform various operations without the need to anonymize the data. As explained throughout, in some example embodiments, the aggregation system 250 can be integrated into a database clean room, as depicted and described above with reference to FIG. 2, FIGS. 4A and 4B, FIG. 9, FIG. 11, FIGS. 18A and 18B, and FIGS. 19A, 19B, and 19C, and/or used in conjunction with, parallel to, or in combination with the constraint system 240 as depicted and described above with reference to FIG. 2. The database clean room enables two or more end-users of the cloud data platform 102 to share and collaborate on their sensitive data, without directly revealing that data to other participants.

The aggregation system 250 includes an aggregation constraint generation component 1402, a query receiving component 1404, a data accessing component 1406, a table identification component 1408, an aggregation constraint determination component 1410, a query context determination component 1412, an enforcement determination component 1414, and an aggregation constraint enforcement component 1416. Although the example embodiment of the aggregation system 250 includes multiple components, a particular example of the aggregation system can include varying components in the same or different elements of the cloud data platform 102.

The aggregation constraint generation component 1402 enables entities to establish aggregation constraints (e.g., aggregation constraint policies) to shared datasets. For example, the aggregation constraint generation component 1402 can provide a user interface or other means of user communication that enables one or more entities to define aggregation constraints in relation to data associated with a provider or consumer, where the data is maintained and managed via the cloud data platform 102. The aggregation constraint generation component 1402 can allow a user of the cloud data platform 102 to define an aggregation constraint, such as an aggregation policy to provide a set of guidelines and rules that determine how data is collected, processed, managed, presented, shared, or a combination thereof for data analysis.

The aggregation constraint generation component 1402 enables users to provide data defining one or more shared datasets and tables to which the one or more aggregation constraints should be attached. Further, the aggregation constraint generation component 1402 enables users to define conditions for triggering the aggregation constraint, which can include defining the specific context(s) that triggers enforcement of (e.g., application of) the aggregation constraint. For example, the aggregation constraint generation component 1402 can enable users to define roles of users, accounts, shares, or a combination thereof, which would trigger the aggregation constraint and/or are enabled to aggregate the constrained table of data.

The query receiving component 1404 receives a query (e.g., request) directed to one or more shared datasets. The query can include information defining data to be accessed, shared, and one or more operations to perform on the data, such as any type of operation used in relation to data maintained and managed by the cloud data platform 102 (e.g., JOIN operation, READ operation, GROUP-BY operation, etc.). The query receiving component 1404 can provide the data associated with the query to other components of the aggregation system 250.

The data accessing component 1406 accesses (e.g., receives, retrieves, etc.) a set of data based on a query received by the query receiving component 1404 or other related component of the cloud data platform 102. For example, the data accessing component 1406 can access data from tables or other database schema of the shared dataset that are identified by the query or are needed to generate an output (e.g., shared dataset) based on the received query. The table identification component 1408 is configured to determine the table(s) associated with the data accessed by the data accessing component 1406 in response to a query. The table identification component 1408 can provide information (e.g., data, metadata, etc.) identifying the table(s) to other components of the cloud data platform 102 and/or to other components of the aggregation system 250, such as the aggregation constraint determination component 1410.

The aggregation constraint determination component 1410 is configured to determine whether an aggregation constraint (e.g., an aggregation constraint policy, aggregation policy, etc.) is attached to any of the tables identified by the table identification component 1408. For example, the aggregation constraint determination component 1410 determines or identifies whether a file defining an aggregation constraint is attached to or corresponds with any of the tables or other database schema identified by the table identification component 1408.

The query context determination component 1412 is configured to determine or identify a context associated with a received query. For example, the query context determination component 1412 can use data associated with a received query to determine the context, such as by determining a role of the user that submitted the query, an account of the cloud data platform 102 associated with the submitted query, a data share associated with the query, and the like. The query context determination component 1412 can provide data defining the determined context of the query to other components of the aggregation system 250, such as the enforcement determination component 1414. The enforcement determination component 1414 can be configured to determine whether an aggregation constraint should be enforced in relation to a received query.

If a query constraint is not attached to any of the tables, the aggregation constraint enforcement component 1416 determines that an aggregation constraint should not be enforced in relation to the specific query. However, if an aggregation constraint is attached to one of the tables, the aggregation constraint enforcement component 1416 uses the context of the query to determine whether the aggregation constraint should be enforced. For example, if the aggregation constraint should be enforced, the aggregation system can generate, or cause to be generated, an output that does not include the data values stored in the tables but can provide an output determined based on the aggregation-constrained data. For example, the aggregation constraint enforcement component 1416 can use the context of the query to determine whether conditions defined in a file attached to or associated with the table are satisfied in order to trigger the aggregation constraint. In some examples, the aggregation constraint enforcement component 1416 can use the context of the query as an input into a Boolean function defined by the aggregation constraint to determine whether the aggregation constraint is triggered and should be enforced or not enforced. According to some examples, the aggregation constraint enforcement component 1416 provides different return type options to an aggregation policy. For example, the return type can be a string where the aggregation policy returns a specific formatted string to specify the allowed actions that a compiler will understand as an aggregation configuration (e.g., min_group_size>10). In some examples, the return type can be an object where the aggregation policy body uses the object construct to specify allowed actions as a key value pair (e.g., object_construct (‘min group_size,’ 10). In some examples, the return type can be an abstract data type (e.g., AGGREGATION_CONFIG).

The aggregation constraint enforcement component 1416 can prohibit an output to a query from including data values from any constrained tables of a shared dataset. For example, this can include denying a query altogether based on the operations included in the query (e.g., if the query requests to simply output the values of a constrained table). The aggregation constraint enforcement component 1416 can enable many other operations to be performed while maintaining the confidentiality (e.g., privacy) of data values in restricted tables or other database schema.

For example, different combinations of aggregation constraint responses are considered, such as (a) rejecting the query (or request) if it queries individual rows rather than requesting one or more aggregate statistics across rows, (b) if the aggregate statistics for any given group of rows contains a sufficient number of rows (e.g., the “minimum group size”), the statistic for this group is included in the query result, (c) if the aggregate statistics for a given group does not meet the minimum group size threshold, these rows are combined into a remainder group, referred to herein as a residual group, that contains all rows for which the group size threshold was not met, and/or (d) an aggregate statistic is computed for the remainder group as well, and also included in the query result (when the remainder group itself meets the minimum group size threshold). Example embodiments can include some combinations or all combinations (e.g., parts (a) and (b) only, parts (a)/(b)/(c), or additional aggregation constraint responses may be added).

As an example, and in accordance with some example embodiments, the aggregation system 250 can implement aggregation constraints in a clean room to perform database end-user intersection operations (e.g., companies A and Z would like to know which database end-users they have in common, without disclosing PII of the user's customers). For example, the aggregation system 250 can implement aggregation constraints in a clean room to perform enrichment operations. For instance, a company can implement the aggregation system 250 to provide enrichment analytics.

In some example embodiments, aggregation constraints can be enforced by aggregation system 250 when a query is submitted by a user and compiled. A SQL compiler of the aggregation system 250 analyzes each individual table accessed based on the query to determine the lineage of that table (e.g., where the data came from). In some example embodiments, the constraint-based approach of aggregation system 250 is integrated in a SQL based system as discussed, here, however it is appreciated that the constraint-based approaches of the aggregation system 250 can be integrated with any different query language or query system, other than SQL, in a similar manner. In this way, a user submits a query, and the aggregation system 250 determines the meaning of the query, considers any applicable aggregation constraints, and ensures that the query complies with applicable constraints. In some example embodiments, if the data is from an aggregation-constrained table(s), then the aggregation system 250 checks whether the aggregation constraint should be enforced based on context, such as the role of the user performing the query. If the aggregation constraint is intended to be enforced, then the aggregation system 250 prevents the column, or any values derived directly from that column, from being included in the query output. In some example embodiments, the constrained table(s) is permitted to be used based on specific pre-configured conditions (e.g., in WHERE clauses for filter conditions, GROUP BY clauses for aggregation queries, etc.), and other contexts.

In some example embodiments, the aggregation system 250 implements constraints using a native policy framework of the cloud data platform 102 (e.g., dynamic data masking (column masking) and Row Access Policies). In some example embodiments, similar to a masking policy of the cloud data platform 102, the aggregation system 250 attaches a given aggregation constraint policy to one or more specific tables. In these example embodiments, the aggregation constraint policy body is evaluated to determine whether and how to limit access to that table when a given query is received from a consumer end-user.

Some example embodiments provide different forms of constraints to give providers more ways to protect their data. For example, providers can be enabled to limit the rate at which consumers can issue queries, the fraction of the dataset the consumer can access (e.g., before or after filters are applied), and/or the types of data that can be combined together in a single query. In some example embodiments, differential privacy can be implemented by a DP-aggregation constraint. Further example embodiments provide enhanced audit capabilities to allow providers to closely monitor how consumers are using provider data. For example, a provider can find out if a data consumer is crafting a sequence of abusive queries to attempt to expose PII about a specific individual.

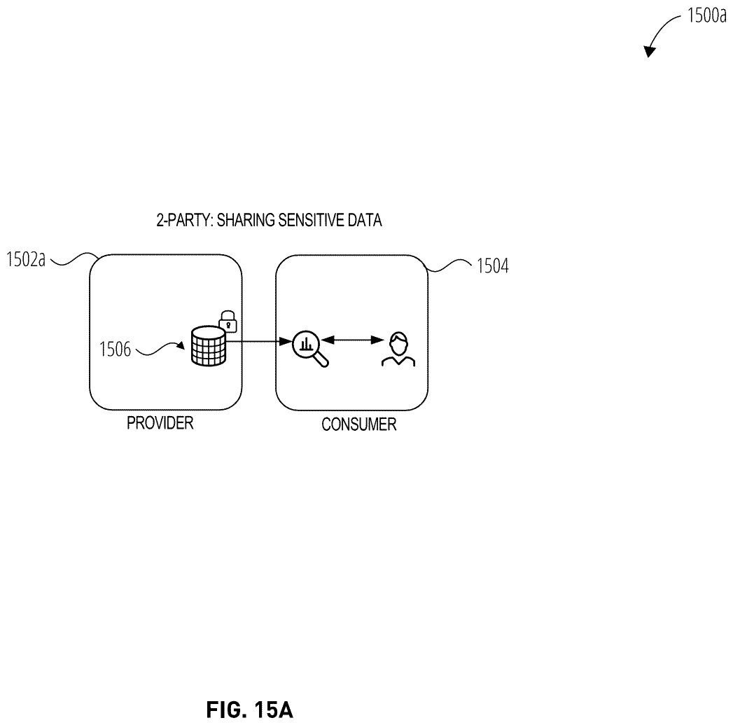

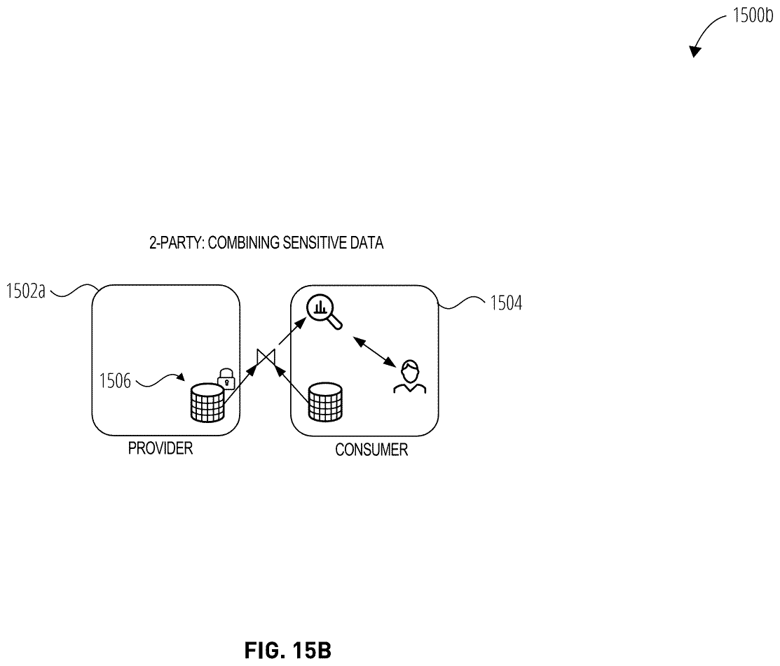

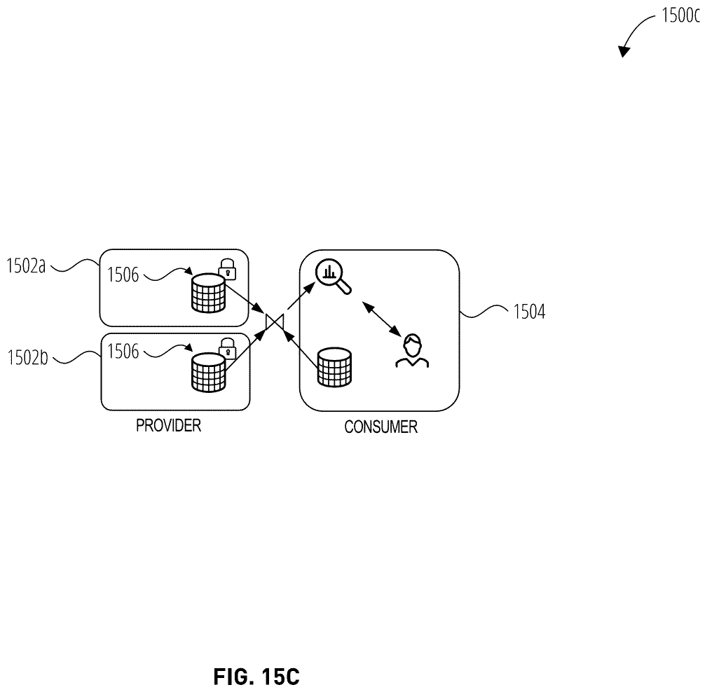

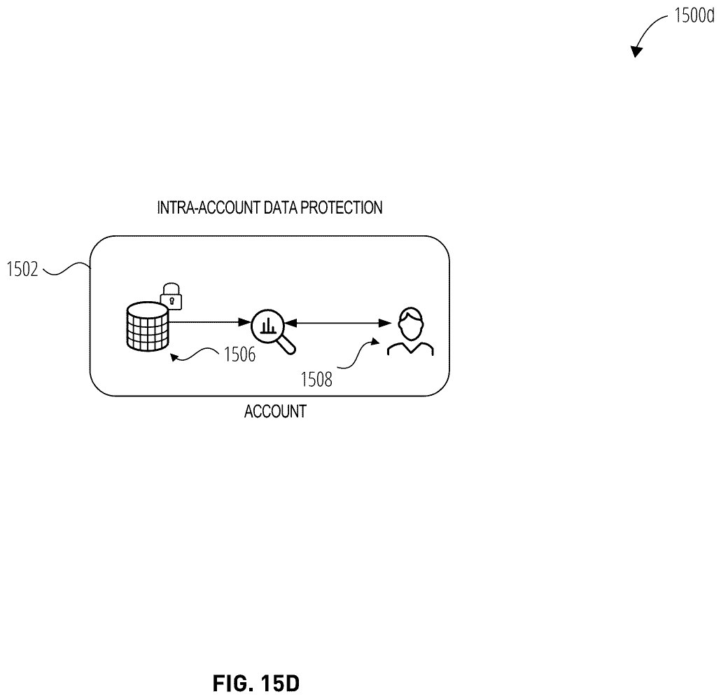

FIG. 15A to FIG. 15D illustrates various data sharing scenarios in which aggregation constraints may be implemented, in accordance with some example embodiments.

FIG. 15A illustrates a data sharing scenario 1500a in which a first provider 1502a shares their data with one or more consumers 1504, according to example embodiments.

In this type of scenario, the shared data 1506 (e.g., shared dataset) is associated with and managed by a single entity (e.g., first provider 1502a) and shared with one or more other entities (e.g., consumers 1504). The shared data 1506 is therefore not a combination of data provided by multiple entities. In this type of scenario, the aggregation system 250 may be implemented to enforce aggregation constraints on queries submitted by the one or more consumers 1504.

A first provider 1502a can implement aggregation constraints to protect any sensitive data by dictating which tables of data cannot be aggregated by the consumers 1504. For example, the first provider 1502a may establish an aggregation constraint to prohibit each of the consumers 1504 from aggregating data in a protected table or set an aggregation constraint to vary whether the data can be aggregated based on the context of the query, such as which consumer 1504 submitted a query. According to the example embodiment of FIG. 15A, a provider user shares data with one or more consumer users, where the consumer queries must satisfy the provider's query constraint (e.g., aggregation constraint). In the two-party sharing of sensitive data, information flow is unidirectional.

FIG. 15B illustrates a two-party data sharing scenario 1500b for combining sensitive data in which a first provider 1502a shares data with a consumer 1504 and the shared data 1506 is combined with the consumer's 1504 data, according to example embodiments.

In this type of scenario, the shared data 1506 is associated with and managed by a single entity (e.g., first provider 1502a) and shared with one or more other entities (e.g., consumers 1504), which combine the shared data 1506 with their own data. In this type of scenario, the aggregation system 250 may be implemented to enforce aggregation constraints on queries submitted by the one or more consumers 1504. A first provider 1502a can implement aggregation constraints to protect any sensitive data by dictating which tables of data cannot be used by the consumers 1504 via queries, while allowing the consumer 1504 to perform operations on the shared data 1506 based on the consumer's data. For example, the consumer 1504 may perform operations to determine and output a number of matches between the consumer's data and data in the constrained tables of the shared data 1506 but may be prohibited from aggregating the data values of the constrained tables.

As in the example, shown in FIG. 15A, the first provider 1502a may establish an aggregation constraint to prohibit each of the consumers 1504 from aggregating data in a protected table or set an aggregation constraint to vary whether the data can be aggregated based on the context of a query, such as which consumer 1504 submitted a query. According to the example embodiment of FIG. 15B, a provider user shares data protected by one or more aggregation constraints with one or more consumer users. The consumer user's queries are combined with provider data and consumer data, where the cloud data platform or component thereof (or trusted database processing system) enforces the provider user's aggregation constraints. In the two-party combining of sensitive data, information flow can be unidirectional or bidirectional.

FIG. 15C illustrates a data sharing scenario 1500c in which data shared by multiple providers, such as a first provider 1502a and a second provider 1502b, is combined and shared with a consumer 1504, according to example embodiments.

In this type of scenario, the shared data 1506 is a combination of data associated with and managed by multiple entities (e.g., first provider 1502a, second provider 1502b, etc.) and the shared data 1506 is shared with one or more other entities (e.g., consumers 1504). In this type of scenario, the aggregation system 250 may be implemented to enforce aggregation constraints on queries submitted by the one or more consumers 1504. Each of the first provider 1502a and/or the second provider 1502b can implement aggregation constraints to protect any sensitive data shared by the respective first provider 1502a by dictating which tables of the data cannot be aggregated by the consumers 1504. In this type of embodiment, a query submitted by a consumer 1504 would be evaluated based on the query constraints provided by each first provider 1502a.

The shared data 1506 may be accessed by a consumer 1504 without being combined with the consumer's data, as shown in FIG. 15A, or a consumer 1504 may combine the shared data 1506 with the consumer's own data, as shown in FIG. 15B. Each of the first provider 1502a and/or the second provider 1502b may establish aggregation constraints to prohibit each of the consumers 1504 from aggregating data in a protected table or set an aggregation constraint to vary whether the data can be aggregated based on the context of a query, such as which consumer 1504 submitted a query. According to the example embodiment of FIG. 15C, data is combined from N number of parties, where N−1 providers share data with one or more consumers, and all consumer queries must satisfy all providers' aggregation constraints. In the N-parties combining sensitive data, information flow can be unidirectional, bidirectional, and/or multidirectional.

FIG. 15D illustrates a data sharing scenario 1500d in which a first provider 1502 shares data with one or more internal users 1508, according to example embodiments.

In this type of scenario, the shared data 1506 is data associated with and managed by a single entity (e.g., first provider 1502) and the shared data 1506 is shared with one or more other users associated with the entity (e.g., internal users 1508). In this type of scenario, the aggregation system 250 may be implemented to enforce aggregation constraints on queries submitted by the one or more internal users.

The first provider 1502 can implement aggregation constraints to protect any sensitive data shared by the first provider 1502 by dictating which tables of the data cannot be aggregated by the internal users 1508. For example, the first provider 1502 may establish aggregation constraints to prohibit each of the internal users 1508 from aggregating data in a protected table or set an aggregation constraint to vary whether the data can be aggregated based on the context of a query, such as the role of the internal user(s) 1508 that submitted a query.

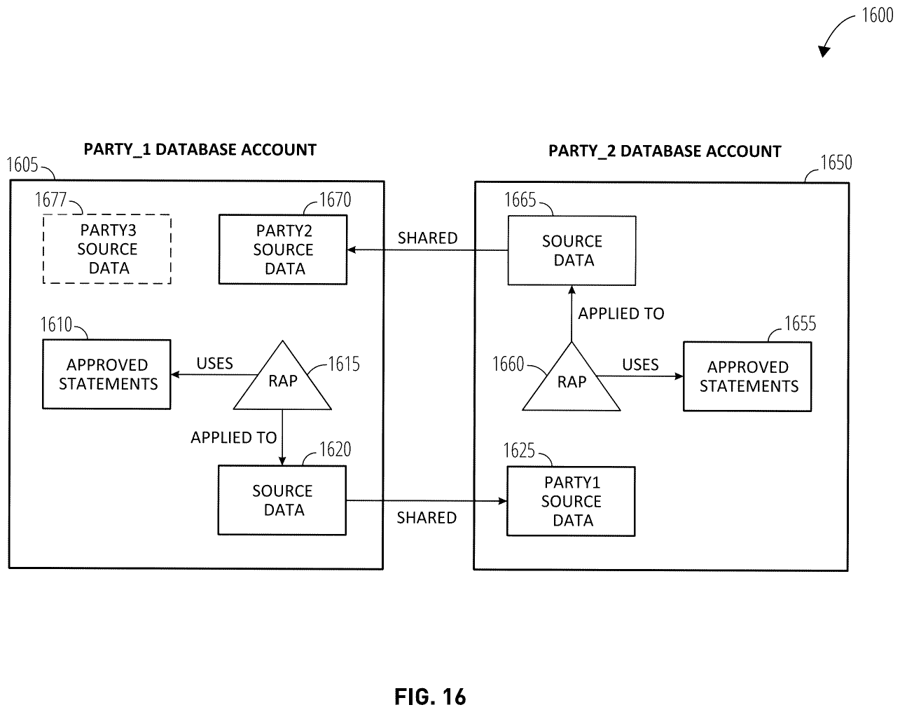

FIG. 16 shows a block diagram 1600 illustrating details of a dynamically restricted data clean room system 230, according to some example embodiments.

In the dynamically restricted data clean room system 230, a first database account 1605 and a second database account 1650 share data in a data clean room system 230 against which queries can be issued by either account. In the following example, the first database account 1605 provides data to the second database account 1650 (e.g., using approved statements table 1610, row access policy engine first RAP 1615, source data 1620, and first-party shared source data 1625), and it is appreciated that the second database account 1650 can similarly share data with the first database account 1605 (e.g., using approved statements table 1655, row access policy engine second RAP 1660, source data 1665, and second-party shared source data 1670).

In the example of FIG. 16, the data clean room system 230 implements a row access policy scheme (e.g., first row access policy engine 1615, second row access policy engine 1660) on the shared datasets of the first and second database accounts (e.g., source data 1620, source data 1665). In some example embodiments, the second row access policy engine 1660 is implemented as a database object of the cloud data platform 102 that restricts source data of a database account for use and/or sharing in the clean room. In some example embodiments, a database object in the cloud data platform 102 is a data structure used to store and/or reference data. In some example embodiments, the cloud data platform 102 implements one or more of the following objects: a database table, a view, an index, a stored procedure of the cloud data platform, a user-defined function of the cloud data platform, or a sequence.

In some examples, when the cloud data platform 102 creates a database object type, the object is locked, and a new object type cannot be created due to the cloud data platform 102 restricting the object types using the source code of the cloud data platform. In some example embodiments, when objects are created, a database object instance is what is created by the cloud data platform 102 as an instance of a database object type (e.g., such as a new table, an index on that table, a view on the same table, or a new stored procedure object). The second row access policy engine 1660 provides row-level security to data of the cloud data platform 102 through the use of row access policies to determine which rows to return in the query result. Examples of a row access policy include allowing one particular role to view rows of a table (e.g., user role of an end-user issuing the query), or including a mapping table in the policy definition to determine access to rows in a given query result. In some example embodiments, a row access policy is a schema-level object of the cloud data platform 102 that determines whether a given row in a table or view can be viewed from different types of database statements including SELECT statements or rows selected by UPDATE, DELETE, and MERGE statements.

In some example embodiments, the row access policies include conditions and functions to transform data at query runtime when those conditions are met. The policy data is implemented to limit sensitive data exposure. The policy data can further limit an object's owner (e.g., the role with the OWNERSHIP privilege on the object, such as a table or view) who normally has full access to the underlying data. In some example embodiments, a single row access policy engine is set on different tables and views to be implemented at the same time. In some example embodiments, a row access policy can be added to a table or view either when the object is created or after the object is created.

In some example embodiments, a row access policy comprises an expression that can specify database objects (e.g., table or view) and use Conditional Expression Functions and Context Functions to determine which rows should be visible in a given context. The following is an example of a row access policy being implemented at query runtime: (A) for data specified in a query, the cloud data platform 102 determines whether a row access policy is set on a database object. If a policy is added to the database object, all rows are protected by the policy. (B) The distributed database system then creates a dynamic secure view (e.g., a secure database view) of the database object. (C) The policy expression is evaluated. For example, the policy expression can specify a “current statement” expression that only proceeds if the “current statement” is in the approved statements table or if the current role of the user that issued the query is a previously specified and allowed role. (D) Based on the evaluation of the policy, the restriction engine generates the query output, such as source data to be shared from a first database account to a second database account, where the query output only contains rows based on the policy definition evaluating TRUE.

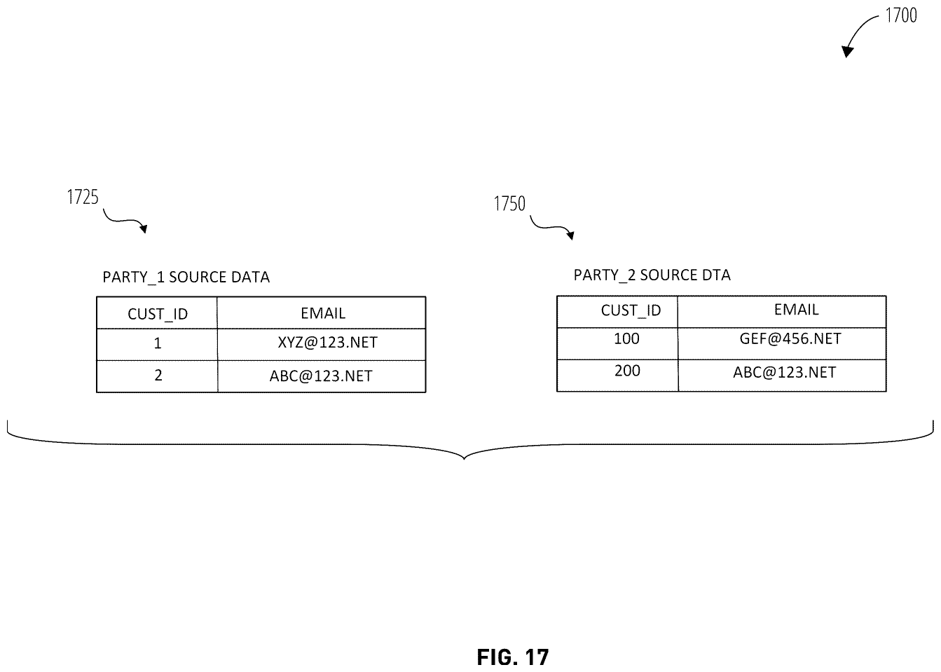

Continuing with reference to FIG. 16, the contents of the approved statements table is agreed upon or otherwise generated by the first database account 1605 and second database account 1650. For example, the users managing the first database account 1605 and second database account 1650 agree upon query language that is acceptable to both and include the query language in the approved statements table, and the agreed upon language is stored in the approved statements table 1610 on the first database account 1605 and also stored in the approved statements table 1655 in the second database account 1650. As an illustrative example, the source data 1620 of the first database account 1605 can include a first email dataset, such as the first email dataset in table 1725 in FIG. 17, of the first database account's users, and the source data 1665 of the second database account 1650 can include a second email dataset, such as the second email dataset in table 1750 in FIG. 17, of the second database accounts users (further described in connection with FIG. 17).

The two database accounts may seek to determine how many of their user email addresses in their respective datasets match, where the returned result is a number (e.g., each has end users and the two database accounts are interested in how many users they share, but do not want to share the actual users' data). To this end, the two database accounts store “SELECT COUNT” in the approved query requests table. In this way, a counting query that selects and joins the source data can proceed, but a “SELECT *” query that requests and potentially returns all user data cannot proceed because it is not in the approved statements tables of the respective dataset accounts (e.g., the approved statements table 1610 and the approved statements table 1655).

Further, although only two database accounts are illustrated in FIG. 16, the data clean room system 230 enables two or more database accounts to share data through the clean room architecture. In past approaches, data clean room data is obfuscated (e.g., tokenized) and then shared in a data clean room, and the complexity of matching obfuscated data can result in limiting the data clean room data to only two parties at a time. In contrast, in the example approach of FIG. 16, a third database account (not illustrated in FIG. 16) can provide a third-party shared dataset 1677 using the data clean room system 230 in the compute service manager 108, and database statements can be issued that join data from the three datasets, such as a SELECT COUNT on a joined data from the source data 1620, the second-party shared source data 1670 from the second database account 1650, and the third-party shared dataset 1677 from the third database account (e.g., as opposed to a requester database account sharing data with a first provider database account, and the requester database account further correlating the data with another second provider database account using sequences of encrypted functions provided by the first and second provider accounts), in accordance with some example embodiments.

FIG. 17 illustrates a block diagram 1700 including two example data tables 1725 and 1750, according to some example embodiments.

As an illustrative example, the source data of the first database account table 1725 can include a first email dataset of the first database account's users, and the source data of the second database account table 1750 can include a second email dataset of the second database accounts users.

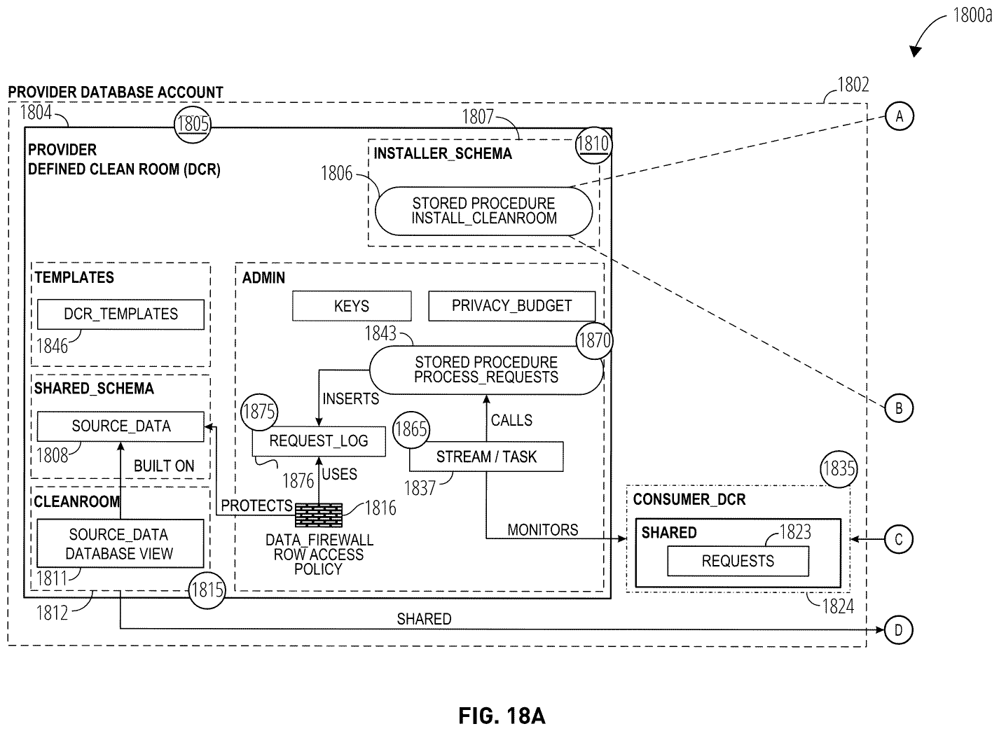

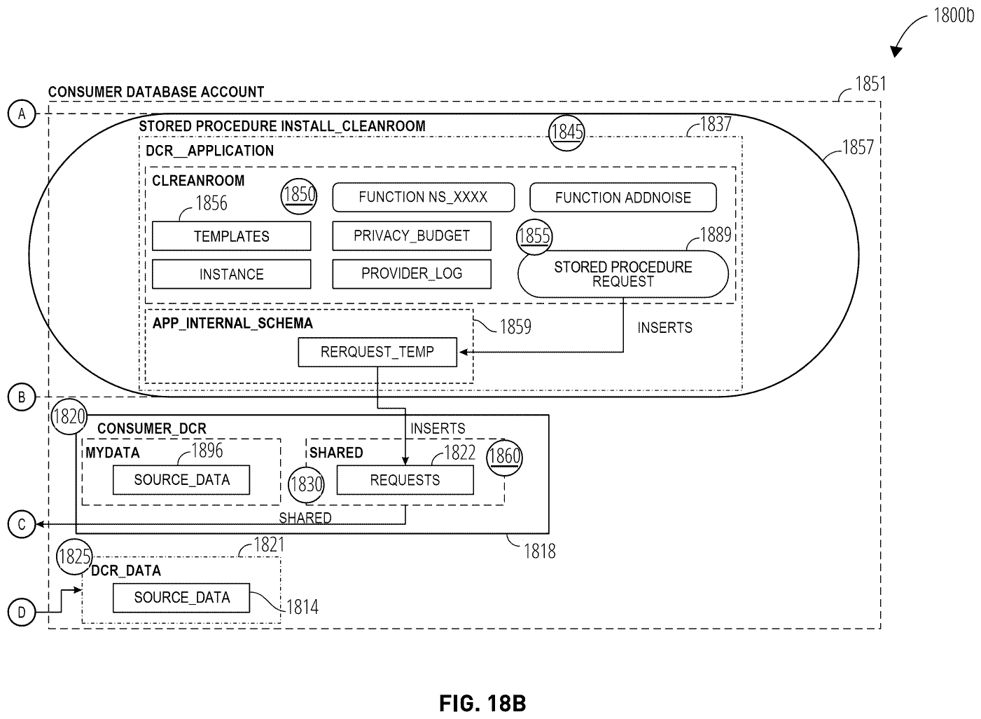

FIG. 18A and FIG. 18B show example data architectures 1800a and 1800b for implementing defined access clean rooms using native applications, in accordance with some example embodiments.

In some example embodiments, a native application is configured so that a provider can create local state objects (e.g., tables) and local compute objects (e.g., stored procedures, external functions, tasks) and also share objects representing the application logic in the consumer account. In some example embodiments, a native application is installed in the consumer accounts as a database instance that is shareable. For example, a provider can generate a native application that includes stored procedures and external functions that analyze and enrich data in a given consumer account. A consumer can install the provider's native application in the consumer's account as a database and call stored procedures in the installed native application that provide the application functionality. In some example embodiments, the native application is configured to write only to a database in the consumer account. Further, in some example embodiments, a native application of a provider can be packaged with one or more other objects such as tables, views, and stored procedures of the provider account, which are then generated in the consumer account upon installation via an installer script. In some example embodiments, the native application installer script is configured to: (1) create local objects in the consumer account, and (2) control the visibility of objects in native applications with the different consumer accounts that may install the provider's native application.

FIG. 18A shows a provider database account 1802 and FIG. 18B shows a consumer database account 1851 where connections between FIG. 18A and FIG. 18B are shown using capital letters with circles (e.g., A, B, C, and D). With reference to FIG. 18A, at operation 1805, the provider database account 1802 generates a defined access clean room 1804 (DCR). At operation 1810, the provider database account 1802 shares an installer clean room stored procedure 1806 as a native database application with the consumer database account 1851. At operation 1815 in FIG. 18A, the provider database account 1802 shares source data 1808 as a source data database view 1811 in a clean room 1812 which is then accessible by the consumer database account 1851 as source data 1814 (in FIG. 18B). While the source data 1814 is accessible as a share by the consumer database account 1851, the source data 1814 may be empty (e.g., not yet populated) and is controlled by a data firewall 1816, such as a row access policy of the provider database account 1802, as discussed above. In FIG. 18B, at operation 1820, the consumer database account 1851 creates a clean room consumer database 1818 using source data 1896, for example.

At operation 1825, the consumer database account 1851 creates the database store 1821 to store the source data 1814 shared from the provider database account 1802. At operation 1830, the consumer database account 1851 shares a requests table 1822 with the provider database account 1802 as consumer-defined clean room shared requests table 1823 (in FIG. 18A). At operation 1835, the provider database account 1802 creates a consumer store database 1824 to store a requests table 1823 received as a consumer share from the consumer database account 1851. Further, the provider database account 1802 creates a management object 1837 comprising a stream object to track changes on the requests table 1823, and a task object in the management object 1837 to execute the process requests stored procedure 1843 when a new request is input into the requests table 1823 (e.g., a request from the consumer and user that is input into the requests table 1822 and that is automatically shared as an entry in requests table 1823). In FIG. 18B, at operation 1845, the consumer database account 1851 creates a database store 1821 to store the provider's shared source data 1814 (in FIG. 18B), which initiates a stored procedure installer script that generates a runtime instance of a native application 1857. In FIG. 18B, at operation 1850, the execution and creation of the data clean room native application 1857 using the native application installer procedure 1807 creates a clean room schema, and all of the objects within the clean room as specified in the native application installer procedure 1807, in accordance with some example embodiments. Further, the native application installer procedure 1807 grants privileges on the tables and the requested data stored procedure. Further, the native application installer procedure 1807 creates application internal schema 1859 for use in request processing.

At operation 1855, the consumer database account 1851 generates a clean room request by calling the request stored procedure 1889 and passes in a query template name (e.g., of a template from query templates 1856, a template repository), selects groups by columns, filters, a privacy budget to implement, and any other parameters that are required for the query template chosen or otherwise passed in.

At operation 1860, consumer database account 1851 implements the request stored procedure 1889 which is configured to (1) generate a query based on the query template and the parameters passed in, (2) signed the query request using an encryption key created by the data clean room native application 1857 to authenticate to the provider database account 1802 that the data clean room native application 1857 issued the request, (3) apply differential privacy noise parameter to the query results based on an epsilon value (a.k.a. privacy budget) passed in with the query, and (4) when the query is input into the requests table 1822 the query is automatically shared with the provider as an entry in the requests table 1823.

At operation 1865 in FIG. 18A, the provider database account 1802 implemented a stream to capture the insert entry into the requests table 1823 subsequently triggers the task of the management object 1837 to execute the process requests stored procedure 1843. At operation 1870, the process requests stored procedure 1843 executes the query that validates the requests. In some example embodiments, the validation that is performed by the process requests stored procedure 1843 comprises (1) determining that the encrypted request key matches the provider key, (2) confirming that the request originated from a corresponding preauthorized consumer account (e.g., consumer database account 1851), (3) confirming that the query uses a valid template from the templates 1846 (e.g., from a plurality of valid and preconfigured templates authorized by the provider), (4) confirming that the instant ID of data clean room native application 1857 matches the expected instance ID, and (5) confirming that the provider database account 1802 is the expected or preconfigured account. At operation 1875, if the request is valid, the provider database account 1802 updates the status as “approved” in a request log 1876, which configures the data firewall 1816 (e.g., row access policy) to provide access to one or more rows from the source data 1808; where the RAP provided rows are then shared to the consumer database account 1851 as source data 1814. In FIG. 18B, once the data is shared into the source data 1814, the consumer database account 1851 can execute the query within the data clean room native application 1857 on the consumer database account 1851 (e.g., by execution nodes of the consumer database account 1851).

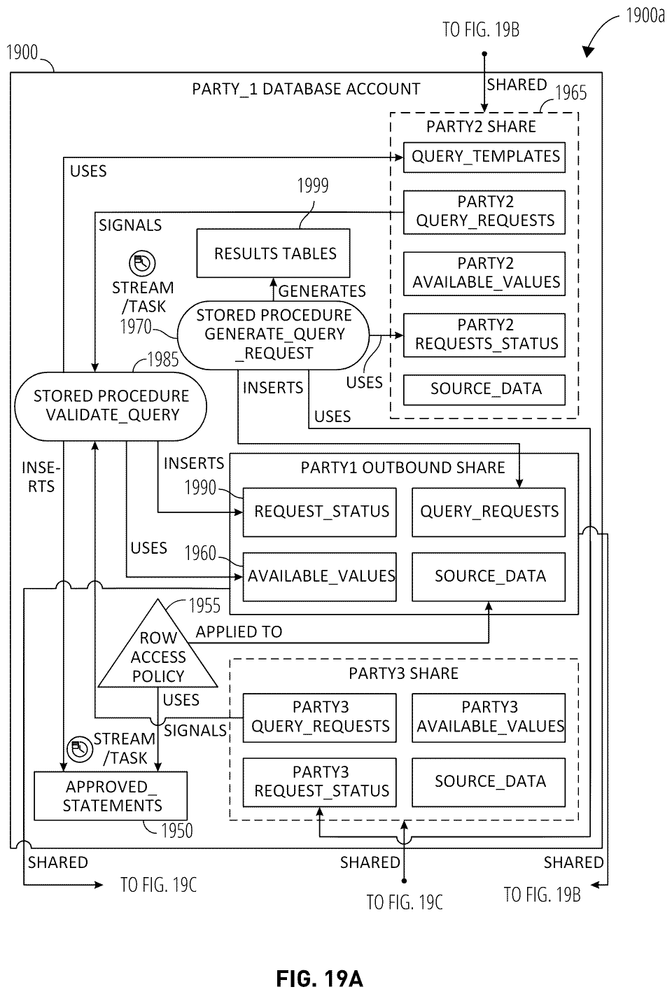

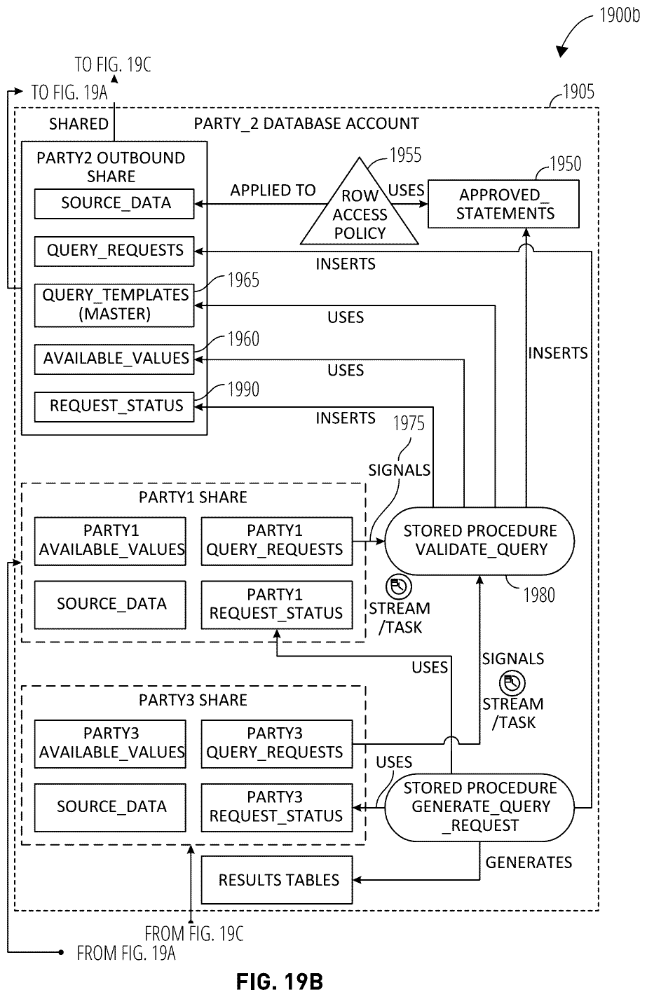

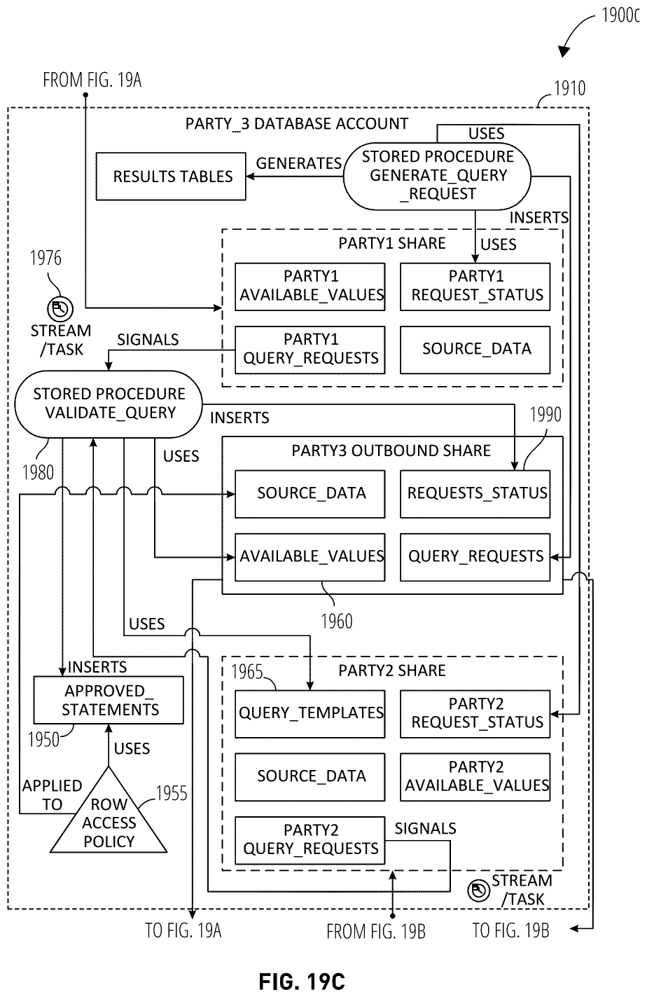

FIG. 19A to FIG. 19C show examples of data clean room architecture 1900a/1900b/1900c for sharing data between multiple parties, according to some example embodiments.

In the illustrated example, party_1 database account 1900 is in FIG. 19A, party_2 database account 1905 is in FIG. 19B, and party_3 database account 1910 is in FIG. 19C, where data is transferred (e.g., replicated, shared) between the different accounts, as indicated by the broken labeled arrows that refer to other figures; for example, in FIG. 19B, a “Party2 Outbound Share” is shared from the party_2 database account 1905 to the party_1 database account 1900 in which the share is labeled as “Party2 Share” and connected by a broken arrow between FIG. 19A and FIG. 19B.

The below data flows refer to operations that each party performs to share data with the other parties of FIG. 19A to FIG. 19C. For example, at approved statements 1950, the party_1 database account 1900 creates its APPROVED_STATEMENTS in its own database instance (e.g., illustrated in FIG. 19A); likewise at approved statements 1950, party_2 database account 1905 creates its APPROVED_STATEMENTS in its own database instance (e.g., illustrated in FIG. 19B), and further, party_3 database account 1910 creates its APPROVED_STATEMENTS in its own database instance (e.g., illustrated in FIG. 19C).

At approved statements 1950, each party creates an APPROVED STATEMENTS table that will store the query request Structured Query Language (SQL) statements that have been validated and approved. In some example embodiments, one of the parties creates the approved statements table, which is then stored by the other parties. In some example embodiments, each of the parties creates their own approved statements table, and a given query on the shared data must satisfy each of the approved statements table or otherwise the query cannot proceed (e.g., “SELECT*” must be in each respective party's approved statements table in order for a query that contains “SELECT*” to operate on data shared between the parties of the cleanroom).

At row access policy 1955, each party creates a row access policy that will be applied to the source table(s) shared to each other party for clean room request processing. The row access policy will check the current_statement( ) function against values stored in the APPROVED_STATEMENTS table.

At available values 1960, each party will generate their AVAILABLE_VALUES table, which acts as a data dictionary for other parties to understand which tables, columns, and/or values they can use in query requests. In some example embodiments, the available values comprise schema, allowed columns, and metadata specifying prohibited rows or cell values. In some example embodiments, the available values data is not the actual data itself (e.g., source data) but rather specifies what data can be accessed (e.g., which columns of the source data) by the other parties (e.g., consumer accounts) for use in their respective shared data jobs (e.g., overlap analysis).

FIG. 19B shows an example of data clean room architecture 1900b for sharing data between multiple parties, including party_2 database account 1905, according to some example embodiments.

At operation 1975, each party has a stream object created against the other party's QUERY_REQUESTS table, capturing any inserts to that table. A task object will run on a set schedule and execute the VALIDATE_QUERY stored procedure if the stream object has data. At operation 1980, the VALIDATE_QUERY procedure is configured to: (1) Ensure the query request select and filter columns are valid attributes by comparing against the AVAILABLE_VALUES table. (2) Ensure the query template accepts the variables submitted. (3) Ensure the threshold or other query restrictions are applied. (4) Generate a create table as select (CTAS) statement and store it in the APPROVED_STATEMENTS table if validation succeeds. (5) Update the REQUEST_STATUS table with success or failure. If successful, the create table as select (CTAS) statement is also added to the record.

FIG. 19C shows an example of data clean room architecture 1900c for sharing data between multiple parties, including party_3 database account 1910 where data is transferred (e.g., replicated, shared, etc.) between the different accounts, as indicated by the broken labeled arrows that refer to other figures, according to some example embodiments.

With reference back to FIG. 19C, at second party share 1965, each party agrees on one or more query templates that can be used for query requests. For example, if a media publisher and advertiser are working together in a clean room, they may approve an “audience overlap” query template. The query template would store join information and other static logic, while using placeholders for the variables (select fields, filters, etc.).

As an example, one of the parties is a provider account that specifies which statements are stored in the Available Statements table (e.g., thereby dictating how the provider's data will be accessed by any consumer account wanting to access the provider data). Further, in some example embodiments, the provider account further provides one or more query templates for use by any of the parties (e.g., consumer accounts) seeking to access the provider's data according to the query template. For example, a query template can comprise blanks or placeholders “{{______}}” that can be replaced by specific fields via the consumer request (e.g., the specific fields can be columns from the consumer data or columns from the provider data). Any change to the query template (e.g., adding an asterisk “*” to select all records) will be rejected by the data restrictions on the provider's data (e.g., the Row Access Policies (RAP) functions as a firewall for the provider's data).

Continuing, at stored procedure to generate a query request 1970 (FIG. 19A), one of the parties (e.g., party_1 database account 1900, in this example) will generate a clean room query request by calling the GENERATE_QUERY_REQUEST stored procedure. This procedure will insert the new request into the QUERY_REQUESTS table. This table is shared to each other party, along with the source data table(s) that have the row access policy enabled, the party's AVAILABLE_VALUES table, and the REQUEST_STATUS table.

At signals 1975, each party has a stream 1976 object created against the other party's QUERY_REQUESTS table, capturing any inserts to that table. A task object will run on a set schedule and execute the VALIDATE_QUERY stored procedure if the stream object has data.

At validate query 1980, the VALIDATE_QUERY procedure is configured to: (1) Ensure the query request select and filter columns are valid attributes by comparing against the AVAILABLE_VALUES table. (2) Ensure the query template accepts the variables submitted. (3) Ensure the threshold or other query restrictions are applied. (4) Generate a create table as select (CTAS) statement and store it in the APPROVED_STATEMENTS table if validation succeeds. (5) Update the REQUEST_STATUS table with success or failure. If successful, the create table as select (CTAS) statement is also added to the record.

At stored procedure to validate query the 1985, GENERATE_QUERY_REQUEST procedure will also call the VALIDATE_QUERY procedure on the requesting party's account. This is to ensure the query generated by each additional party and the requesting party matches, as an extra layer of validation.

At request status 1990, the REQUEST_STATUS table, which is shared by each party, is updated with the status from the VALIDATE_QUERY procedure. The GENERATE_QUERY_REQUEST procedure will wait and poll each REQUEST_STATUS table until a status is returned.

At results tables 1999, once each party has returned a status, the GENERATE_QUERY_REQUEST procedure will compare all of the CTAS statements to ensure they match (if status is approved). If they all match, the procedure will execute the statement and generate the results table.

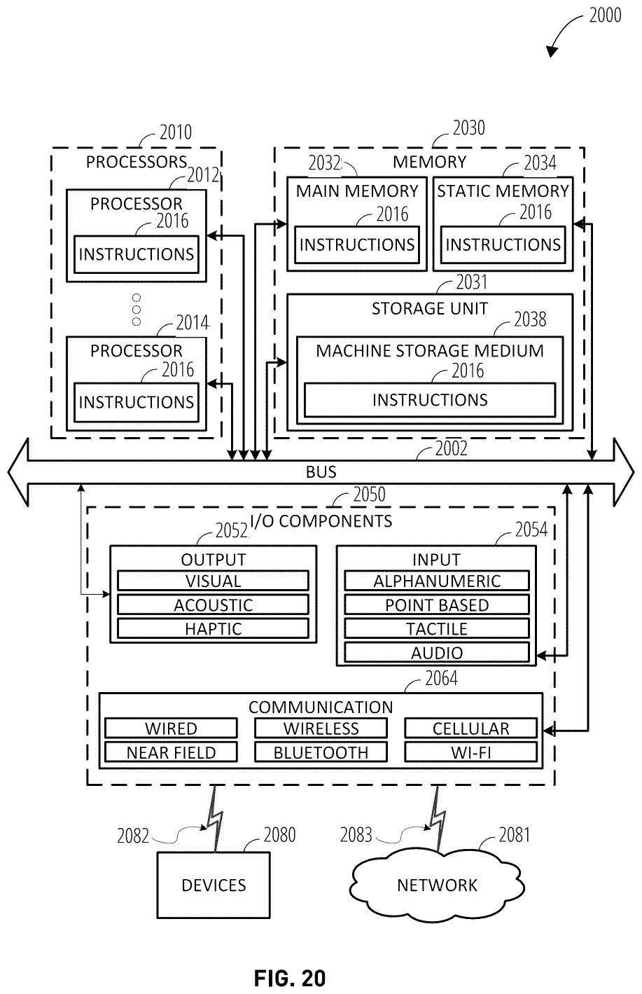

FIG. 20 illustrates a diagrammatic representation of a machine 2000 in the form of a computer system within which a set of instructions may be executed for causing the machine 2000 to perform any one or more of the methodologies discussed herein, according to an example embodiment.

Specifically, FIG. 20 shows a diagrammatic representation of the machine 2000 in the example form of a computer system, within which instructions 2016 (e.g., software, a program, an application, an applet, an app, or other executable code), for causing the machine 2000 to perform any one or more of the methodologies discussed herein, may be executed. For example, the instructions 2016 may cause the machine 2000 to implement portions of the data flows described herein. In this way, the instructions 2016 transform a general, non-programmed machine into a particular machine 2000 (e.g., the client device 114 of FIG. 1, the compute service manager 108 of FIG. 1, the execution platform 110 of FIG. 1) that is specially configured to carry out any one of the described and illustrated functions in the manner described herein.

In alternative embodiments, the machine 2000 operates as a standalone device or may be coupled (e.g., networked) to other machines. In a networked deployment, the machine 2000 may operate in the capacity of a server machine or a client machine in a server-client network environment, or as a peer machine in a peer-to-peer (or distributed) network environment. The machine 2000 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 2016, sequentially or otherwise, that specify actions to be taken by the machine 2000. Further, while only a single machine 2000 is illustrated, the term “machine” shall also be taken to include a collection of machines 2000 that individually or jointly execute the instructions 2016 to perform any one or more of the methodologies discussed herein.

The machine 2000 includes processors 2010, memory 2030, and input/output (I/O) components 2050 configured to communicate with each other such as via a bus 2002. In an example embodiment, the processors 2010 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 2012 and a processor 2014 that may execute the instructions 2016. The term “processor” is intended to include multi-core processors 2010 that may comprise two or more independent processors (sometimes referred to as “cores”) that may execute instructions 2016 contemporaneously. Although FIG. 20 shows multiple processors 2010, the machine 2000 may include a single processor with a single core, a single processor with multiple cores (e.g., a multi-core processor), multiple processors with a single core, multiple processors with multiple cores, or any combination thereof.

The memory 2030 may include a main memory 2032, a static memory 2034, and a storage unit 2031, all accessible to the processors 2010 such as via the bus 2002. The main memory 2032, the static memory 2034, and the storage unit 2031 comprise a machine storage medium 2038 that may store the instructions 2016 embodying any one or more of the methodologies or functions described herein. The instructions 2016 may also reside, completely or partially, within the main memory 2032, within the static memory 2034, within the storage unit 2031, within at least one of the processors 2010 (e.g., within the processor's cache memory), or any suitable combination thereof, during execution thereof by the machine 2000.

The I/O components 2050 include components to receive input, provide output, produce output, transmit information, exchange information, capture measurements, and so on. The specific I/O components 2050 that are included in a particular machine 2000 will depend on the type of machine. For example, portable machines, such as mobile phones, will likely include a touch input device or other such input mechanisms, while a headless server machine will likely not include such a touch input device. It will be appreciated that the I/O components 2050 may include many other components that are not shown in FIG. 20. The I/O components 2050 are grouped according to functionality merely for simplifying the following discussion and the grouping is in no way limiting. In various example embodiments, the I/O components 2050 may include output components 2052 and input components 2054. The output components 2052 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 2054 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 2050 may include communication components 2064 operable to couple the machine 2000 to a network 2081 via a coupler 2083 or to devices 2080 via a coupling 2082. For example, the communication components 2064 may include a network interface component or another suitable device to interface with the network 2081. In further examples, the communication components 2064 may include wired communication components, wireless communication components, cellular communication components, and other communication components to provide communication via other modalities. The devices 2080 may be another machine or any of a wide variety of peripheral devices (e.g., a peripheral device coupled via a universal serial bus (USB)). For example, as noted above, the machine 2000 may correspond to any one of the client device 114, the compute service manager 108, and the execution platform 110, and may include any other of these systems and devices.

The various memories (e.g., 2030, 2032, 2034, and/or memory of the processor(s) 2010 and/or the storage unit 2031) may store one or more sets of instructions 2016 and data structures (e.g., software), embodying or utilized by any one or more of the methodologies or functions described herein. These instructions 2016, when executed by the processor(s) 2010, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, (e.g., erasable programmable read-only memory (EPROM), electrically erasable programmable read-only memory (EEPROM), field-programmable gate arrays (FPGAs), and flash memory devices); magnetic disks such as internal hard disks and removable disks; magneto-optical disks; and CD-ROM and DVD-ROM disks. The terms “machine-storage medium,” “computer-storage medium,” and “device-storage medium” specifically exclude carrier waves, modulated data signals, and other such media, at least some of which are covered under the term “signal medium” discussed below.

In various example embodiments, one or more portions of the network 2081 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 2081 or a portion of the network 2081 may include a wireless or cellular network, and the coupling 2082 may be a Code Division Multiple Access (CDMA) connection, a Global System for Mobile communications (GSM) connection, or another type of cellular or wireless coupling. In this example, the coupling 2082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 2016 may be transmitted or received over the network 2081 using a transmission medium via a network interface device (e.g., a network interface component included in the communication components 2064) and utilizing any one of a number of well-known transfer protocols (e.g., hypertext transfer protocol (HTTP)). Similarly, the instructions 2016 may be transmitted or received using a transmission medium via the coupling 2082 (e.g., a peer-to-peer coupling) to the devices 2080. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 2016 for execution by the machine 2000, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Also, in the above Detailed Description, various features can be grouped together to streamline the disclosure. However, the claims cannot set forth every feature disclosed herein, as embodiments can feature a subset of said features. Further, embodiments can include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

What is claimed is:

1. A method comprising:
receiving a query directed at a shared dataset, the query identifying a operation;
accessing, by at least one hardware processor, a set of data from the shared dataset to perform the operation, the set of data comprising data accessed from a table of the shared dataset;
determining that an aggregation constraint policy is attached to the table, the aggregation constraint policy restricting output of data values stored in the table;
determining, based on a context of the query, that the aggregation constraint policy should be enforced in relation to the query;
assigning a specified noise level to the shared dataset based on the determining that the aggregation constraint policy should be enforced; and
generating an output to the query based on the set of data and the operation, the output to the query comprising data values added to the table based on the specified noise level.

2. The method of claim 1, wherein assigning the specified noise level to the shared dataset further comprises:
adjusting an amount of noise based on a privacy level, wherein the privacy level determines a degree of privacy preservation for the shared dataset.

3. The method of claim 2, further comprising:
determining the privacy level based on at least one of a trust level of a querying party, sensitivity of the shared dataset, risk potential of data exposure, or accuracy of aggregated results.

4. The method of claim 1, wherein the receiving the query directed at the shared dataset further comprises:
determining that the query is attempting to directly access sensitive information; and
rejecting the query when the query is in violation of the aggregation constraint policy.

5. The method of claim 1, further comprising:
providing an interface for a data provider to review and adjust the aggregation constraint policy and the specified noise level; and
controlling an amount of noise per entity granularity based on the context of the query or a context of the aggregation constraint policy.

6. The method of claim 1, further comprising:
applying, based on the aggregation constraint policy, user-specified noise to aggregate functions of the query on a table at runtime; and
identifying a minimum group size, based on the aggregation constraint policy, to be satisfied before returning the output.

7. The method of claim 1, further comprising:
generating aggregate results of the query; and
injecting noise into the aggregate results of the query based on the specified noise level.

8. A system comprising:
one or more hardware processors of a machine; and
at least one memory storing instructions that, when executed by the one or more hardware processors, cause the system to perform operations comprising:
receiving a query directed at a shared dataset, the query identifying a operation;
accessing a set of data from the shared dataset to perform the operation, the set of data comprising data accessed from a table of the shared dataset;
determining, by at least one hardware processor, that an aggregation constraint policy is attached to the table, the aggregation constraint policy restricting output of data values stored in the table;
determining, based on a context of the query, that the aggregation constraint policy should be enforced in relation to the query;
assigning a specified noise level to the shared dataset based on the determining that the aggregation constraint policy should be enforced; and
generating an output to the query based on the set of data and the operation, the output to the query comprising data values added to the table based on the specified noise level.

9. The system of claim 8, wherein assigning the specified noise level to the shared dataset further comprises:
adjusting an amount of noise based on a privacy level, wherein the privacy level determines a degree of privacy preservation for the shared dataset.

10. The system of claim 9, the operations further comprising:
determining the privacy level based on at least one of a trust level of a querying party, sensitivity of the shared dataset, risk potential of data exposure, or accuracy of aggregated results.

11. The system of claim 8, wherein the receiving the query directed at the shared dataset further comprises:
determining that the query is attempting to directly access sensitive information; and
rejecting the query when the query is in violation of the aggregation constraint policy.

12. The system of claim 8, the operations further comprising:
providing an interface for a data provider to review and adjust the aggregation constraint policy and the specified noise level; and
controlling an amount of noise per entity granularity based on the context of the query or a context of the aggregation constraint policy.

13. The system of claim 8, the operations further comprising:
applying, based on the aggregation constraint policy, user-specified noise to aggregate functions of the query on a table at runtime; and
identifying a minimum group size, based on the aggregation constraint policy, to be satisfied before returning the output.

14. The system of claim 8, the operations further comprising:
generating aggregate results of the query; and
injecting noise into the aggregate results of the query based on the specified noise level.

15. A machine-storage medium embodying instructions that, when executed by a machine, cause the machine to perform operations comprising:
receiving a query directed at a shared dataset, the query identifying an operation;
accessing a set of data from the shared dataset to perform the operation, the set of data comprising data accessed from a table of the shared dataset;
determining, by at least one hardware processor, that an aggregation constraint policy is attached to the table, the aggregation constraint policy restricting output of data values stored in the table;
determining, based on a context of the query, that the aggregation constraint policy should be enforced in relation to the query;
assigning a specified noise level to the shared dataset based on the determining that the aggregation constraint policy should be enforced; and
generating an output to the query based on the set of data and the operation, the output to the query comprising data values added to the table based on the specified noise level.

16. The machine-storage medium of claim 15, wherein assigning the specified noise level to the shared dataset further comprises:
adjusting an amount of noise based on a privacy level, wherein the privacy level determines a degree of privacy preservation for the shared dataset;
generating aggregate results of the query; and
injecting the amount of the noise into the aggregate results of the query based on the specified noise level.

17. The machine-storage medium of claim 16, the operations further comprising:
determining the privacy level based on at least one of a trust level of a querying party, sensitivity of the shared dataset, risk potential of data exposure, or accuracy of aggregated results.

18. The machine-storage medium of claim 15, wherein the receiving the query directed at the shared dataset further comprises:
determining that the query is attempting to directly access sensitive information; and
rejecting the query when the query is in violation of the aggregation constraint policy.

19. The machine-storage medium of claim 15, the operations further comprising:
providing an interface for a data provider to review and adjust the aggregation constraint policy and the specified noise level; and
controlling an amount of noise per entity granularity based on the context of the query or a context of the aggregation constraint policy.

20. The machine-storage medium of claim 15, the operations further comprising:
applying, based on the aggregation constraint policy, user-specified noise to aggregate functions of the query on a table at runtime; and
identifying a minimum group size, based on the aggregation constraint policy, to be satisfied before returning the output.
